(19) United States
(12) Patent Application Publication
(10) Pub. No.: US 2026/0264894 A1
(43) Pub. Date: Sep. 10, 2026

(54) ENHANCED SPACESUITS

(71) Applicant: Blue Collar Space Inc, Pleasant Grove, UT (US)

(72) Inventors: Timothy John Keune, Alpine, UT (US); Joseph Robert McRae, Pleasant Grove, UT (US); Jerome Benoit Ramirez, Provo, UT (US)

(21) Appl. No.: 19/558,266

(22) Filed: Mar. 5, 2026

Related U.S. Application Data
(60) Provisional application No. 63/768,011, filed on Mar. 6, 2025.

(51) Int. Cl. B64G 6/00; A42B 3/04; A42B 3/28; A42B 3/30; B64C 39/02

(52) U.S. Cl. CPC B64G 6/00; A42B 3/0406; A42B 3/0426; A42B 3/288; A42B 3/30; B64C 39/026

(57) ABSTRACT

A spacesuit for high altitude and space environments is described herein. The spacesuit may include a helmet having at least one touchscreen on an inner surface of the helmet, a wing suit formed directly onto the helmet, and a pant configured to couple with the wing suit via an airtight lock. The wing suit may include a first sleeve and a second sleeve, where respective first openings of the first sleeve and the second sleeve may be directly attached to a body of the wing suit. The respective first openings of the first sleeve and the second sleeve may be configured to facilitate movement of hands of an occupant of the spacesuit from the first sleeve and the second sleeve into the helmet.

### CROSS REFERENCE

The present Application for Patent claims the benefit of U.S. Provisional Application No. 63/768,011 by Keune et al., entitled “ENHANCED SPACESUITS,” filed Mar. 6, 2025, which is assigned to the assignee hereof, and which is expressly incorporated by reference in its entirety herein.

### BACKGROUND

The following relates generally to spacesuits for high altitude and space environments, including enhanced spacesuits.

Spacesuits, also known as Extravehicular Mobility Units (EMUs), are utilized for human space exploration, providing life support and protection in the harsh environment of space and high altitudes. Some spacesuits may be designed to serve multiple purposes, including extravehicular activity (EVA) outside spacecraft, planetary exploration, and intravehicular activity (IVA) within spacecraft. These suits may be composed of several layers, each serving a specific function. The outermost layer may be constructed from durable materials such as Kevlar or Nomex to protect against micrometeoroids and orbital debris. Beneath the outermost layer, thermal insulation layers may help regulate the astronaut's body temperature, while a pressure garment layer maintains necessary pressure to keep bodily fluids in a liquid state.

Life support systems integrated into spacesuits may include oxygen supply, carbon dioxide removal, temperature control, and waste management. Such life support systems may be housed in a portable life support system (PLSS) backpack, which may also contain communication equipment and power supplies. Mobility and dexterity are significant considerations in spacesuit design. Some suits may incorporate advanced joint bearings and soft fabric joints to enhance flexibility, allowing astronauts to perform complex tasks with greater ease. Gloves may be designed to provide tactile feedback and dexterity while maintaining pressurization and protection. Each component of the spacesuit may be custom-fitted suits, tailored to the individual astronaut's body measurements, which may reduce the risk of injury and increase efficiency during missions. Additionally, the use of advanced materials and manufacturing techniques, such as 3D printing, may allow for more precise and adaptable suit components.

In some cases, however, some spacesuits may fail to provide mobility for an astronaut due to a focus on protection. For example, while thicker, more rigid materials may offer better protection, they can also restrict movement and increase fatigue. Additionally, as space exploration missions extend to more distant and challenging environments, such as Mars, spacesuits may need to evolve to address new hazards. For example, suits designed for planetary exploration may need to protect against dust and radiation while providing greater mobility for walking, climbing, and account for more extended periods of time within the spacesuit.

### SUMMARY

The described techniques relate to improved spacesuits for high altitude and space exploration. For example, the described techniques provide for a spacesuit that includes a helmet comprising at least one touchscreen on an inner surface of the helmet; a wing suit formed directly onto the helmet, the wing suit comprising a first sleeve and a second sleeve, wherein respective first openings of the first sleeve and the second sleeve are directly attached to a body of the wing suit, wherein the respective first openings of the first sleeve and the second sleeve are configured to facilitate the movement of hands of an astronaut from the first sleeve and the second sleeve into the helmet; and a pant configured to couple with the wing suit via an airtight lock.

In some examples, the helmet of the spacesuit may be designed to allow the astronaut's hands to enter the helmet, while satisfying current NASA and SpaceX hatch size requirements. The helmet may also include one or more touchscreen computers on an inner, lower, surface of the helmet, which may be accessed by the astronaut's hands during operation. Such internal touchscreen computer may allow access to project libraries and conference calls. The internal touchscreen computers may also facilitate the use of facial and fingerprint recognition, providing for secure operations. The helmet may also utilize, or otherwise support or contain, the authenticated secure transmission and reception (ASTRO) net system, allowing for point-to-point direct communication.

The helmet may further include a touch screen (e.g., monitor) positioned on a front exterior of the helmet, which may display the vitals of the astronaut and serve as a backup communications panel. In addition to the touch screen, the helmet may include one or more cameras on the exterior of the helmet, including the front exterior, which may directly provide feeds to the internal touch screens of the helmet. That is, the helmet (e.g., and the spacesuit) may include multiple cameras on an exterior of the helmet, where such cameras may feed the associated data to the computer screens within the helmet, thereby providing 360-degree views of the astronaut's surroundings and complete situational awareness.

In some examples, pouches for personal supplies, such as food and drink, may be integrated into the helmet for access during long work periods. Further, the helmet may allow access to an emergency breathing apparatus and include a system for capturing space sickness or vomiting in a bag.

To facilitate the movement of the hands of the astronaut into the helmet of the spacesuit, the spacesuit may include a wing suit that is formed directly onto the helmet. For example, the wing suit may include wing-like sleeves that allow the astronaut's hands to leave the sleeves of the wingsuit and move into the helmet, enhancing functionality and access. An opening of each sleeve of the wing suit, which may attach to a body of the wingsuit, may be larger than an end of the sleeve of the wing suit, thereby forming a tapered, wing-like form. In some examples, the opening of the sleeve may be collapsible, thereby maintaining full movement and mobility, allowing for quick donning and removal of the suit, and increasing the mobility of arm movement

The spacesuit may also feature a system for capturing and removing human waste during missions, eliminating the use of diapers. For example, the spacesuit may include an airlock system may be attached (e.g., integrated) into a body of the wingsuit (or other location of the spacesuit), where the airlock system may facilitate the removal of waste from the spacesuit during missions. Further, the spacesuit may include D-rings attached to various portions of the suit, such as on the sleeves of the wingsuit, at a waist of the spacesuit, among other locations, which may facilitate safety connections while the arm is pulled into the helmet and may provide safety connections during missions, ensuring the astronaut's security and stability.

In some examples, the spacesuit may include an internal protection layer, which may provide thermal (e.g., heat) control for the user. For example, the internal protection layer of the spacesuit may be constructed from quilted material with layered XRI Gel, providing both cooling and heating for the user. Small, low-voltage, wires may run through each quilted section to facilitate temperature control. The temperature of the internal protection layer may be adjusted and altered using the touchscreen computers inside the helmet. By integrating the internal protection layer may eliminate the use of liquid cooling systems in some spacesuits, thereby preventing the risk of space drowning. Further, the internal protection layer and integrated systems may ensure that the astronaut remains comfortable and safe in varying environmental conditions.

### BRIEF DESCRIPTION OF THE DRAWINGS

FIGS. 1A through 1K show examples of a spacesuit 100 for high altitude and space environments in accordance with examples described herein. In some examples, the spacesuit 100 may include a helmet 105, a wingsuit 110, and include a pant 125. As illustrated, the wingsuit 110 may be formed into the helmet 105, such that the wingsuit 110 and the helmet 105 may be considered a single piece of the spacesuit 100.

Further, the wingsuit 110 may include two sleeves 115, where an opening 120 of the two sleeves 115 may include dimensions that are substantially greater than those of an end of the two sleeves 115. The dimensions of the opening 120 of the two sleeves may be further described and illustrated herein with reference to FIGS. 3A and 3B. The wingsuit 110 may enable an astronaut to remove their hands and arms from the sleeves 115 of the wingsuit 110 through the openings 120 and into the helmet 105.

The helmet 105 may include one or more components, such as internal touchscreen computers, communication equipment, pockets for personal items, an emergency release, among other examples, which may be further described herein with reference to FIGS. 2A through 2N.

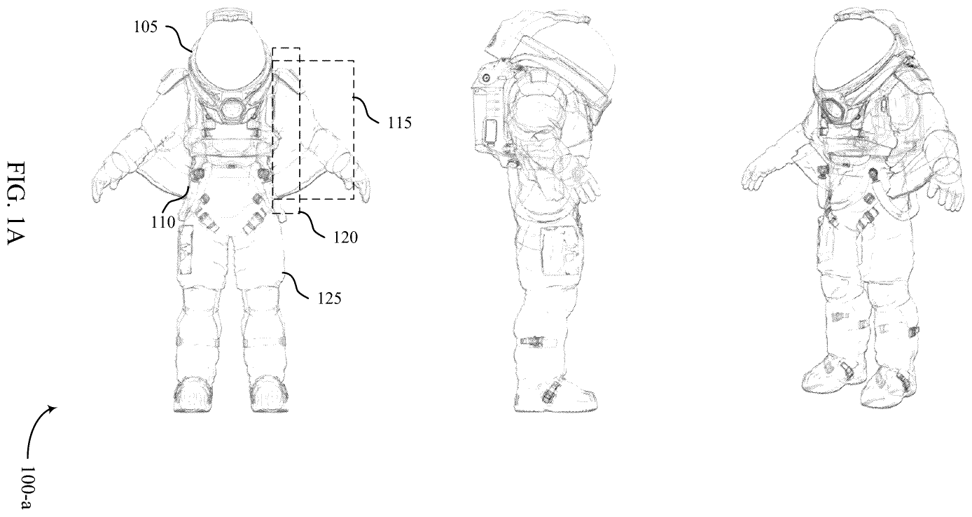

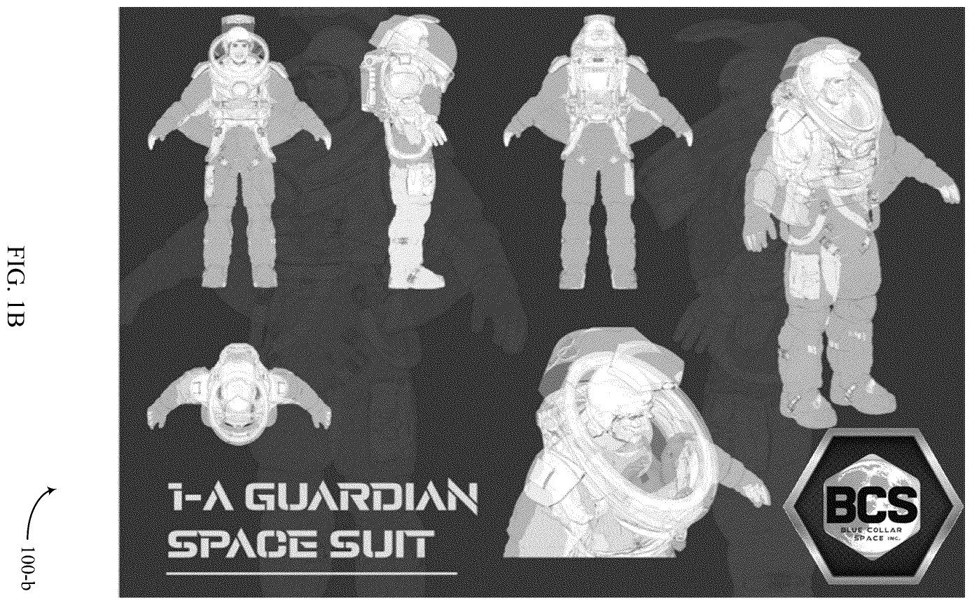

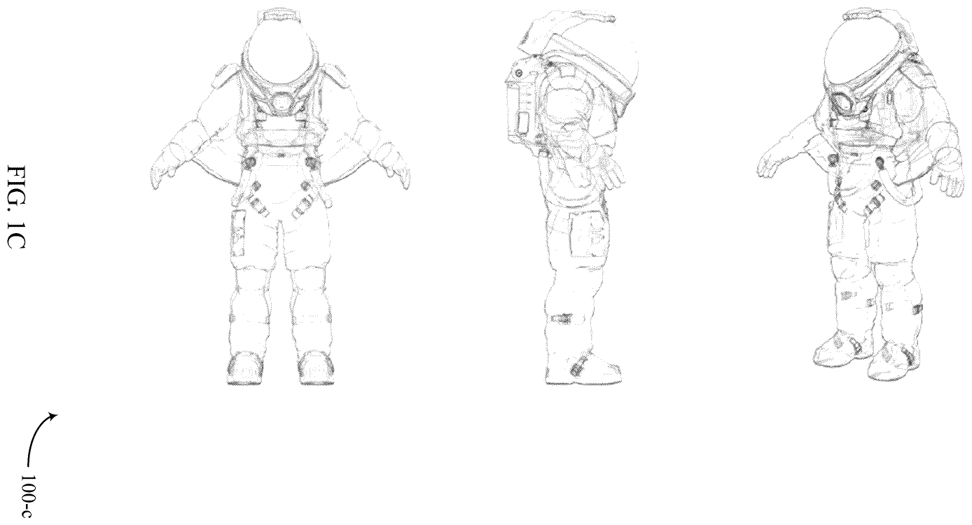

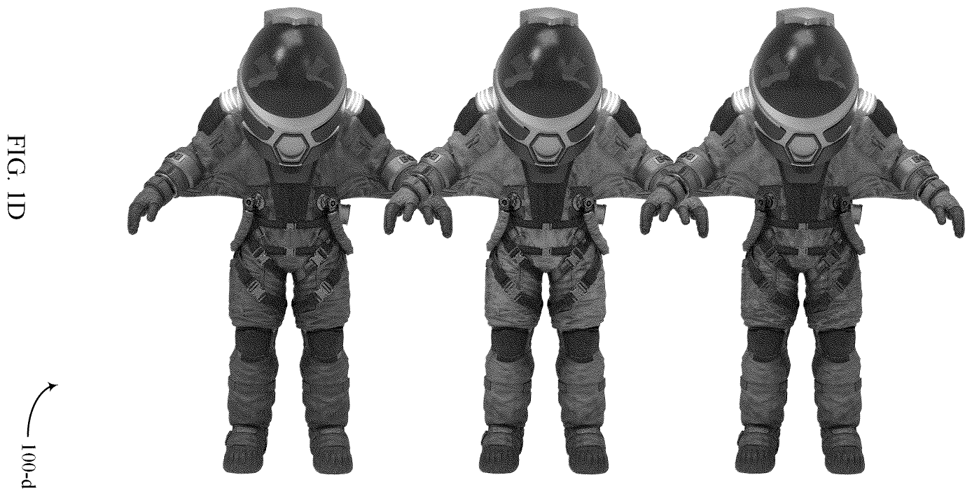

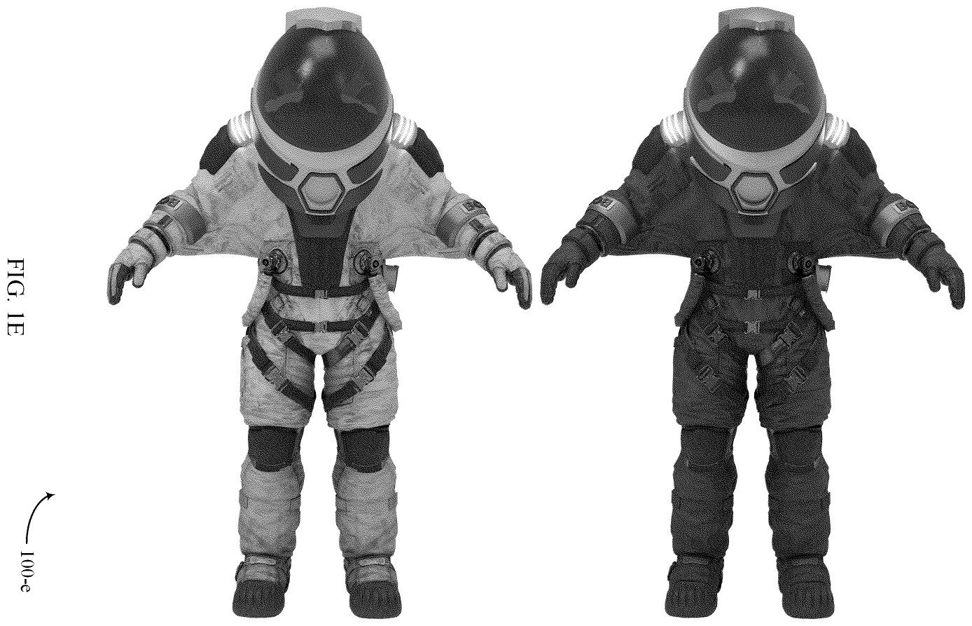

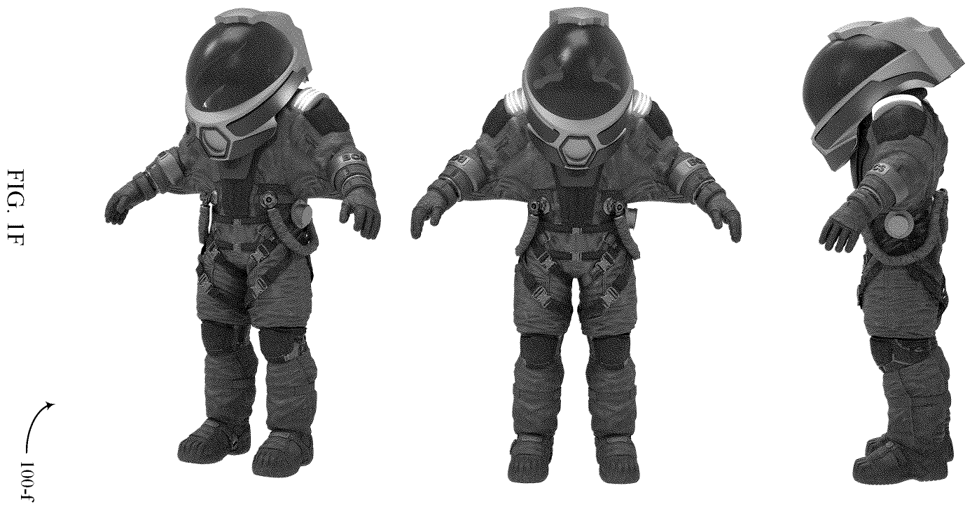

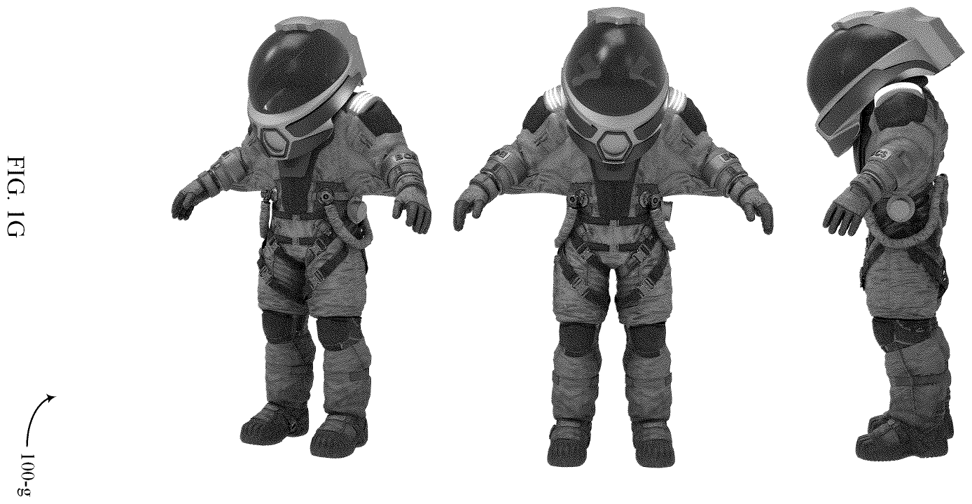

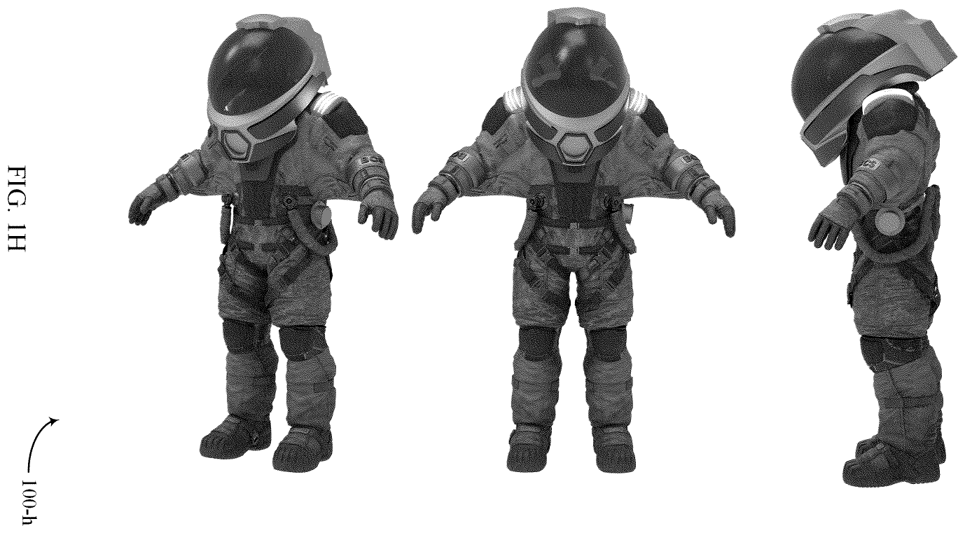

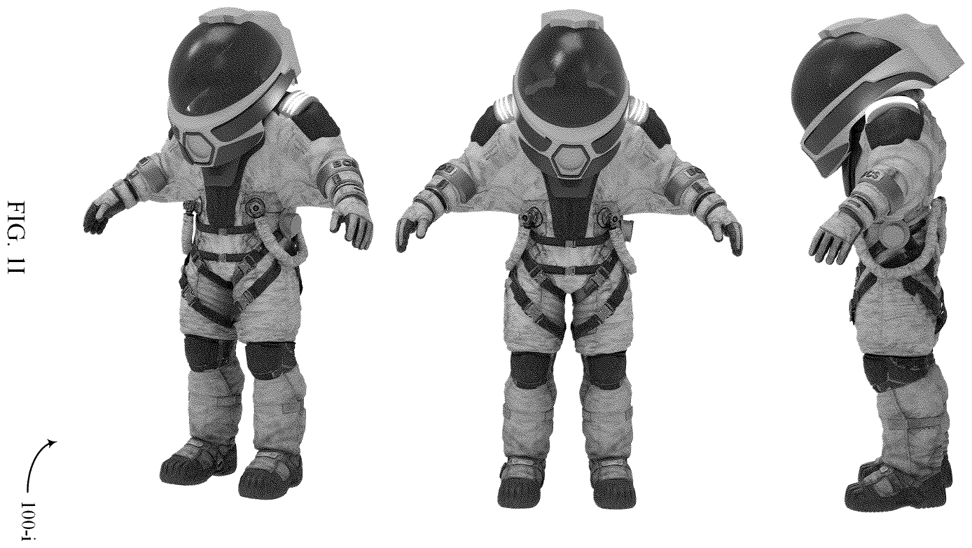

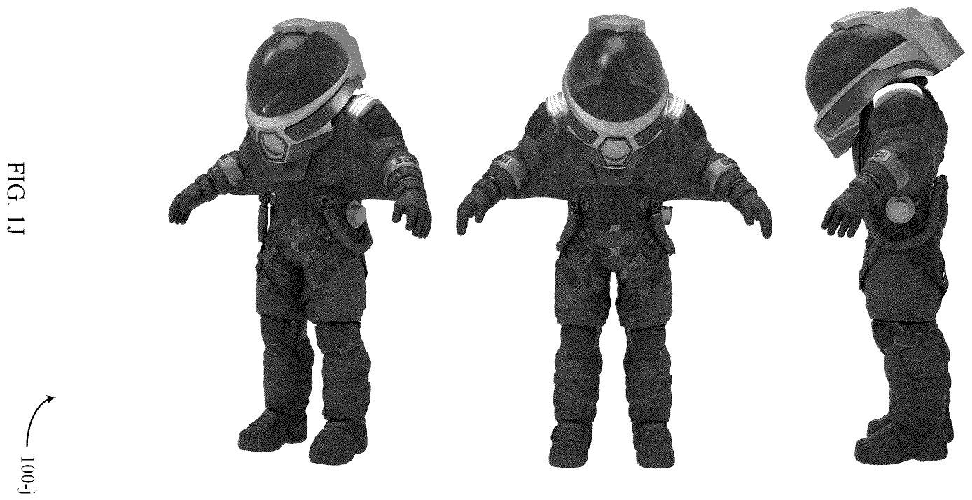

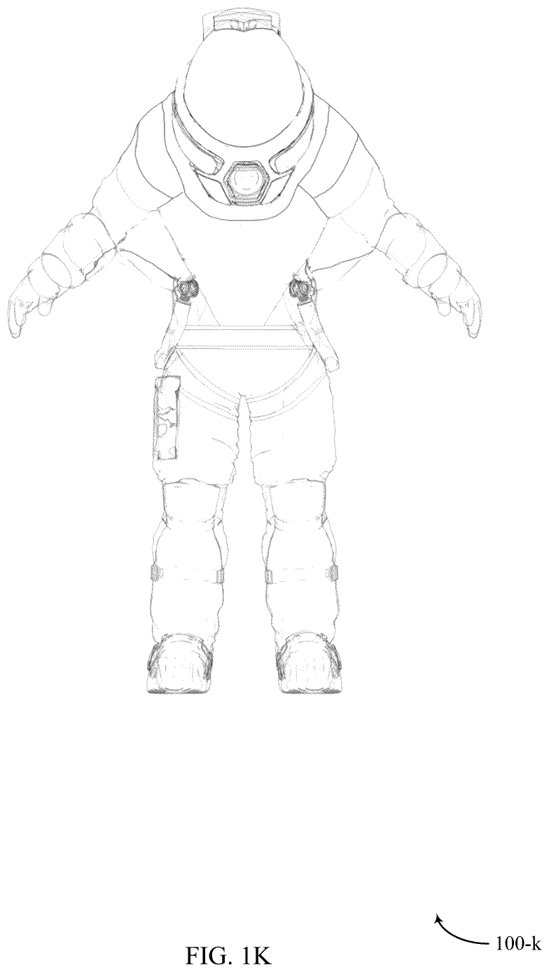

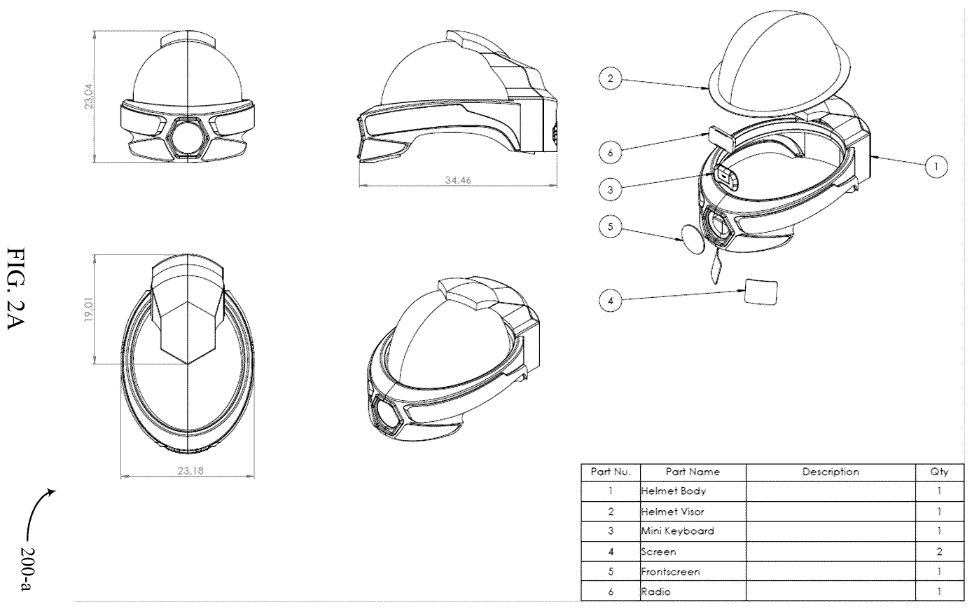

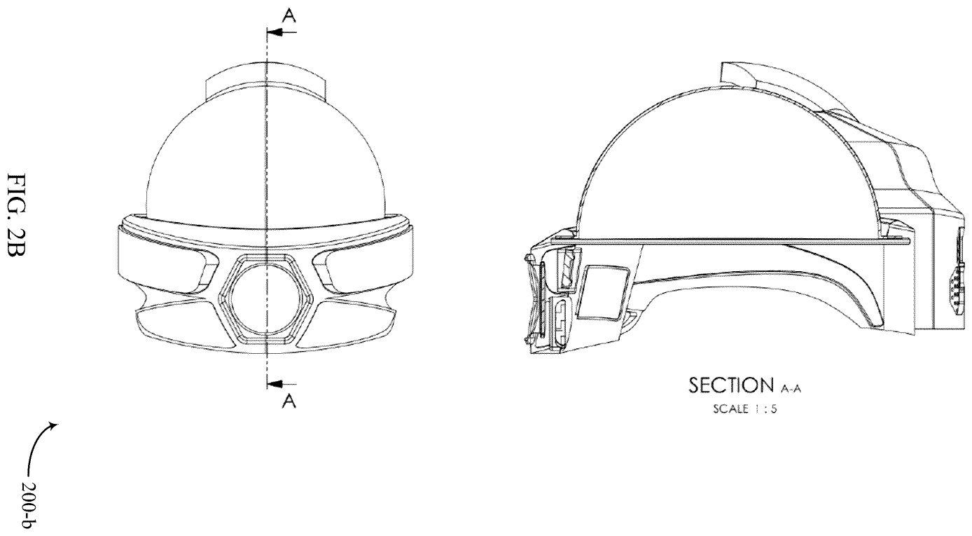

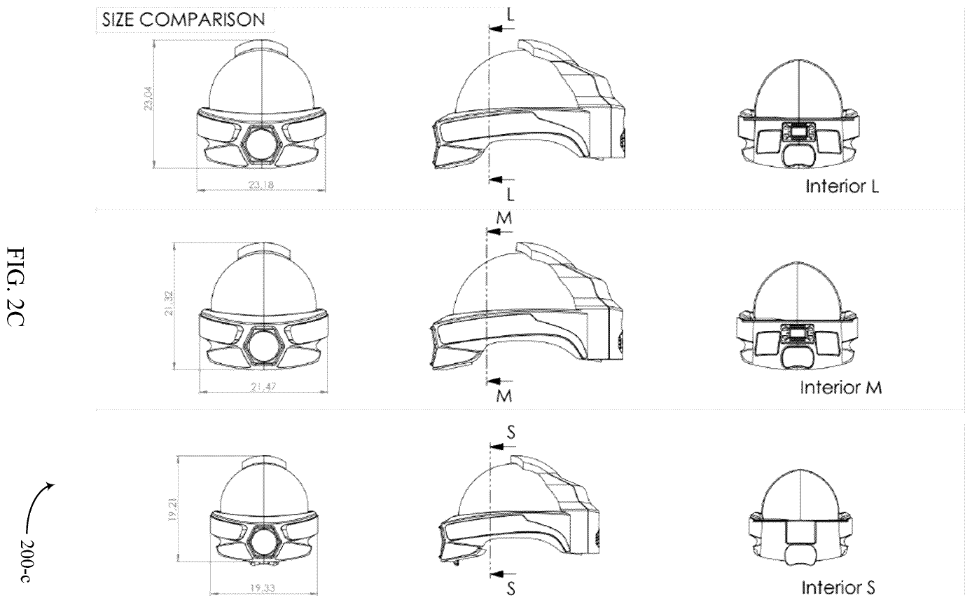

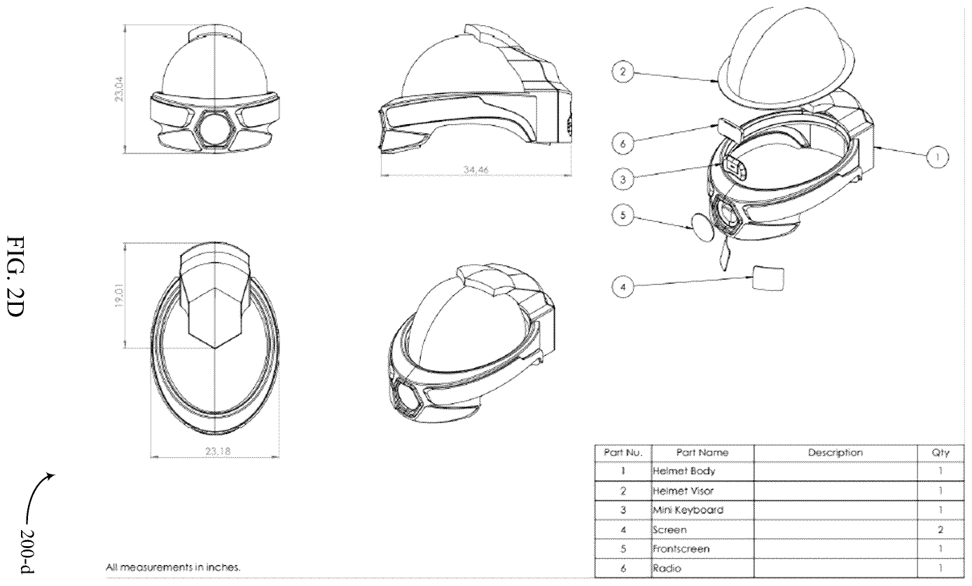

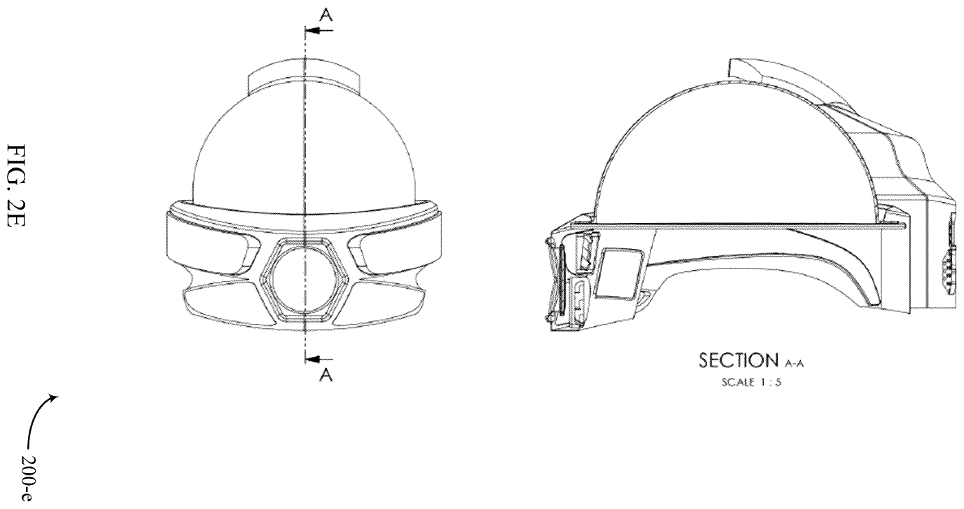

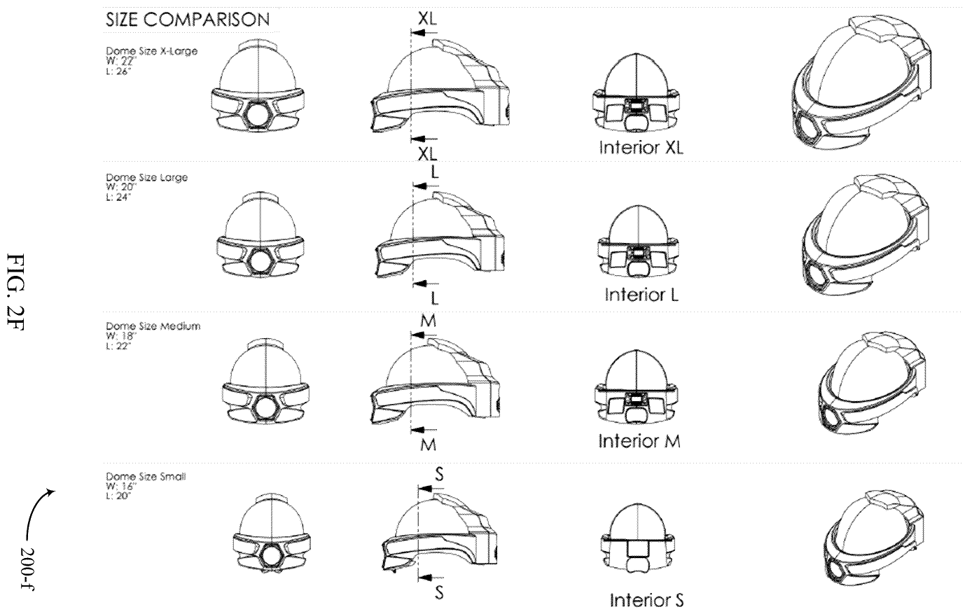

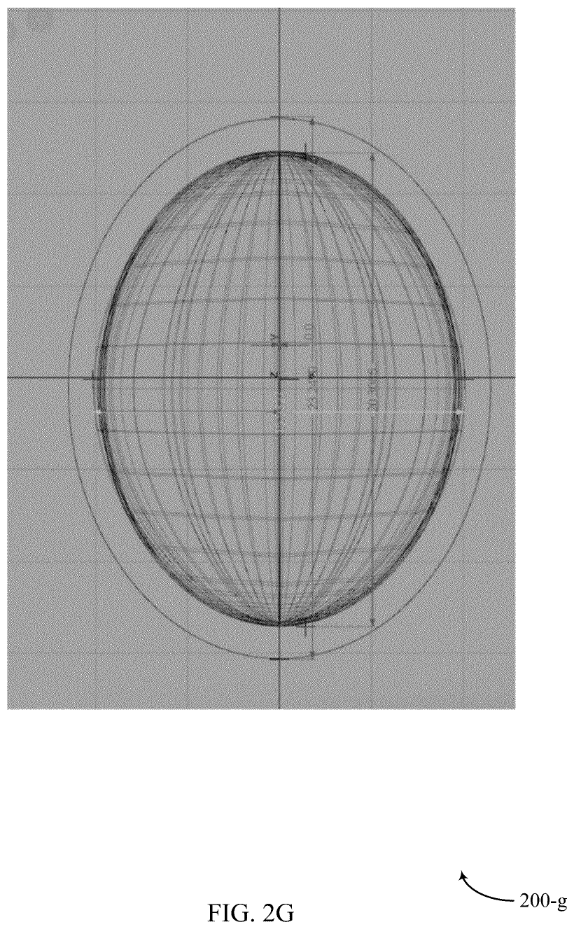

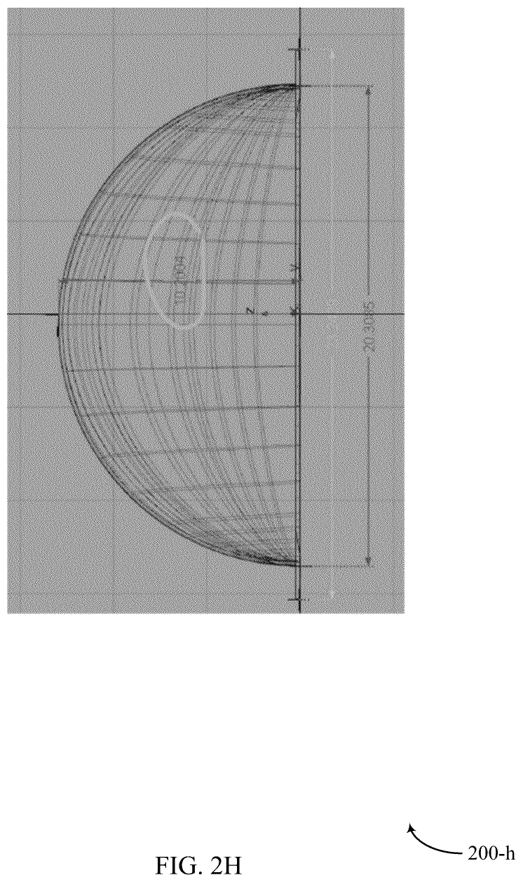

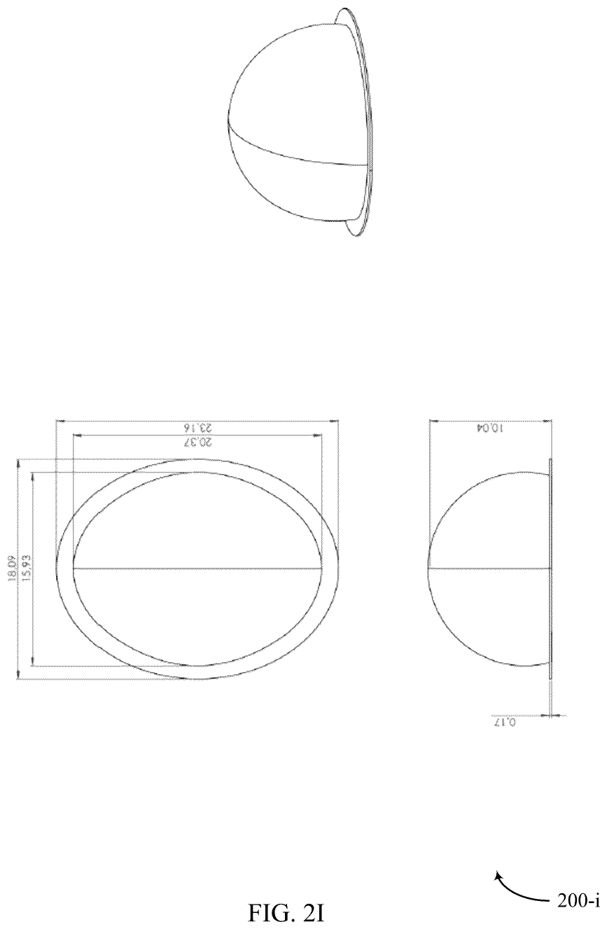

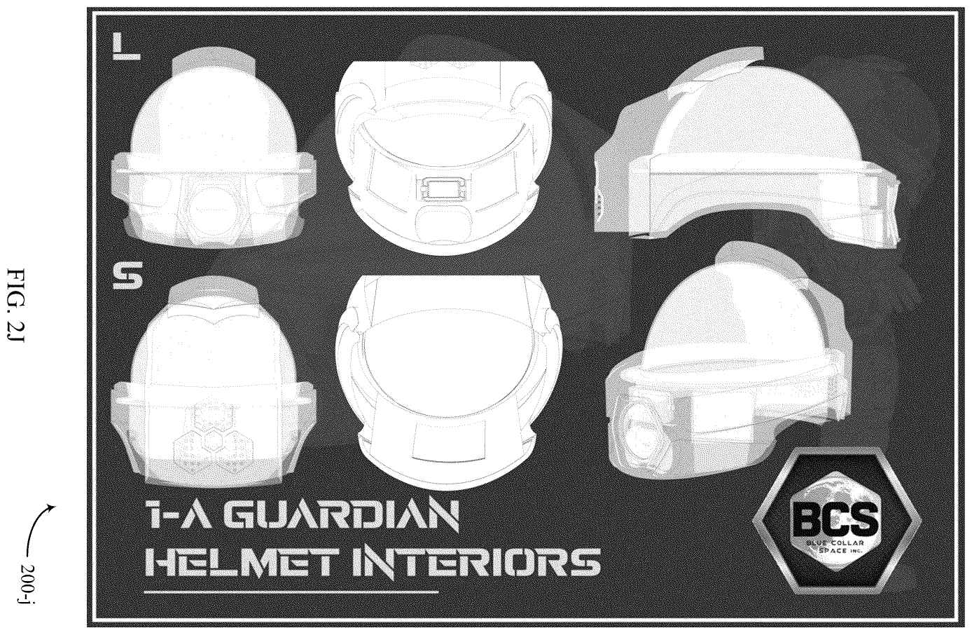

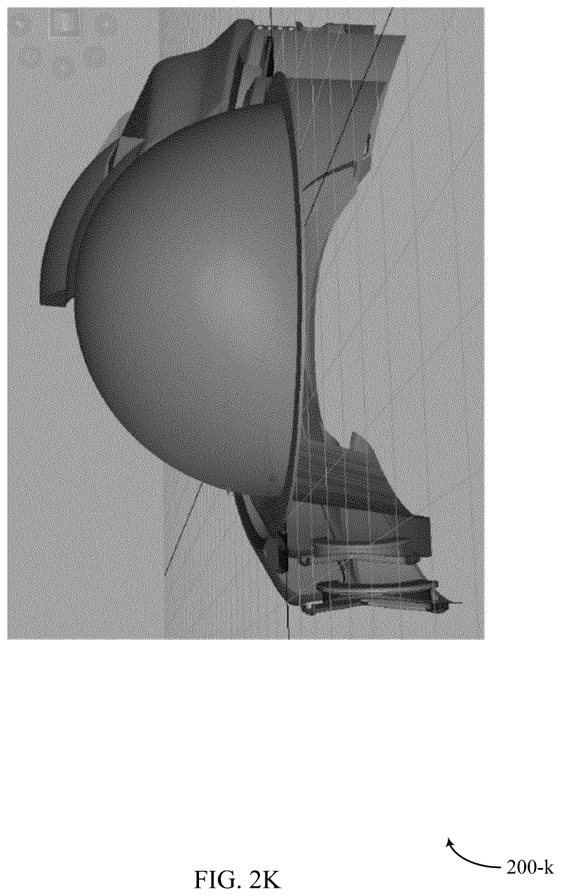

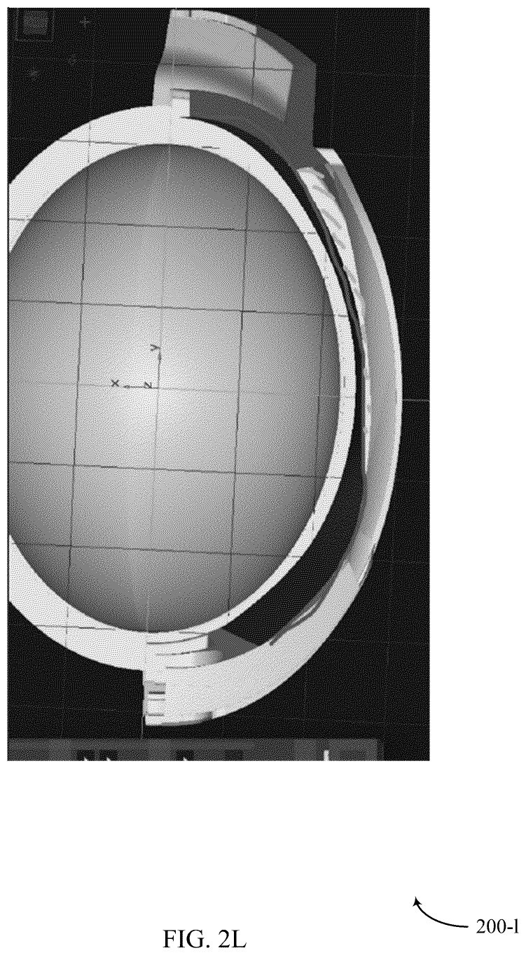

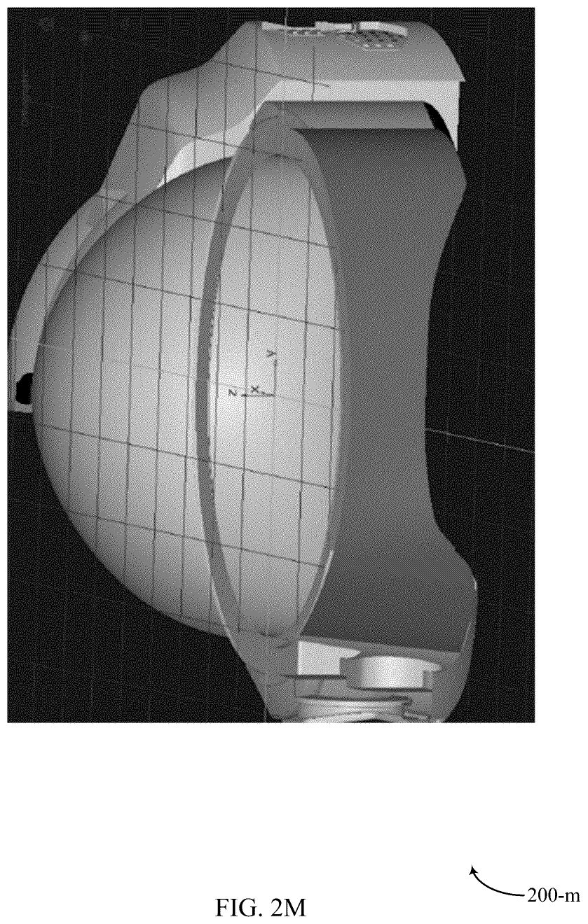

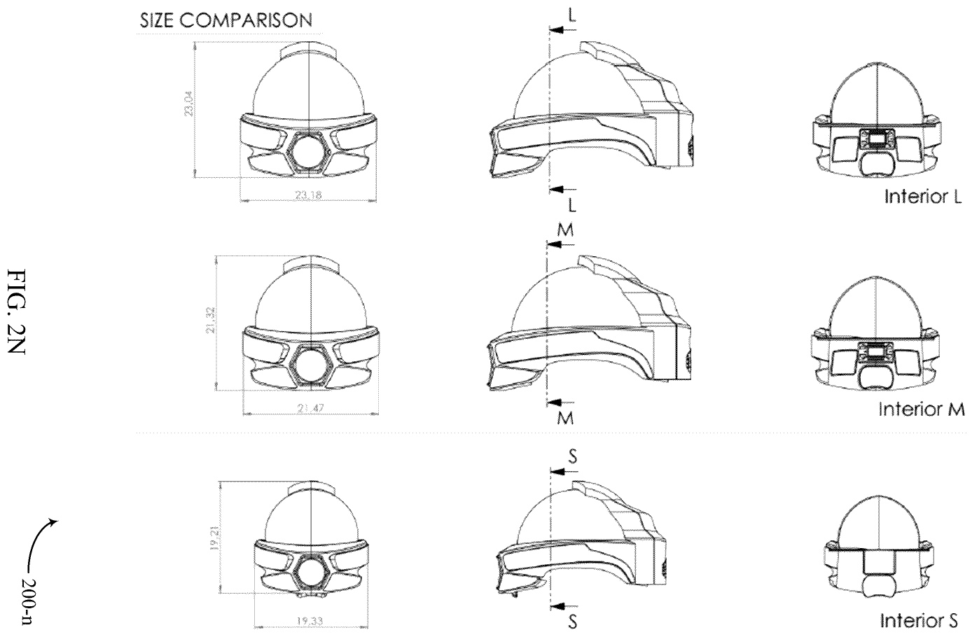

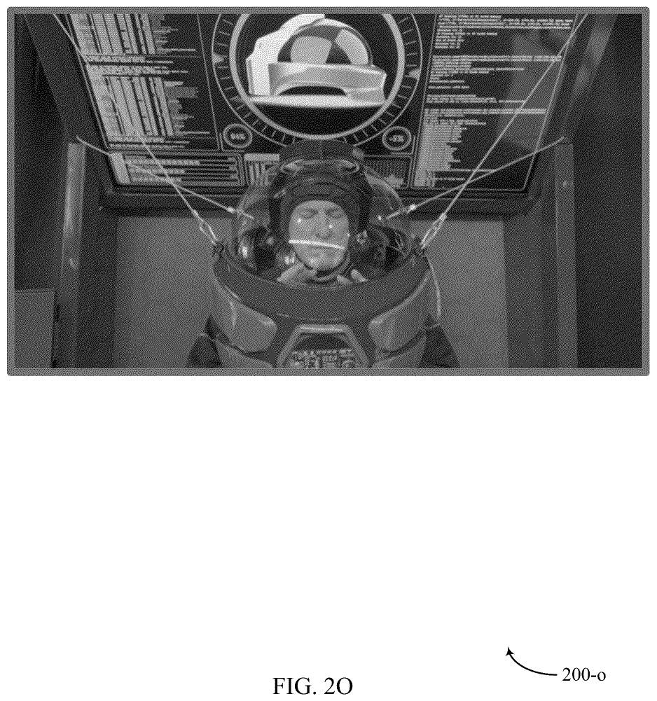

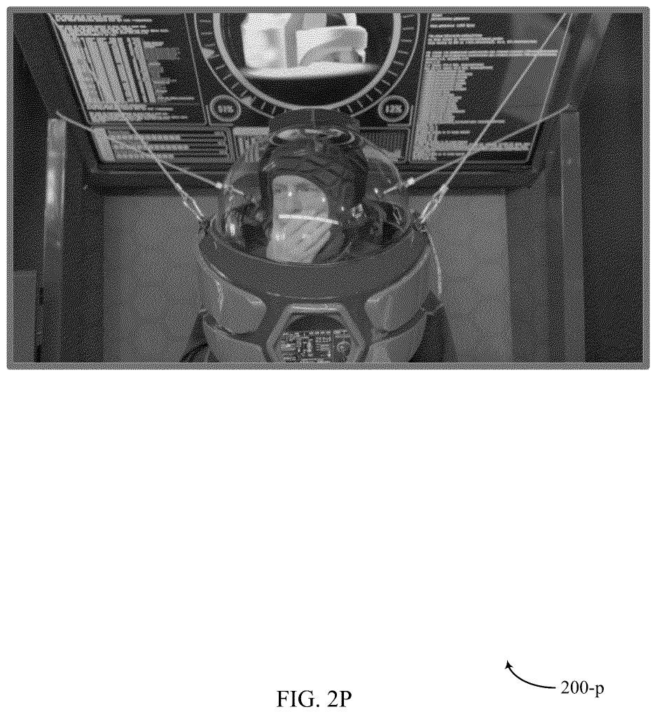

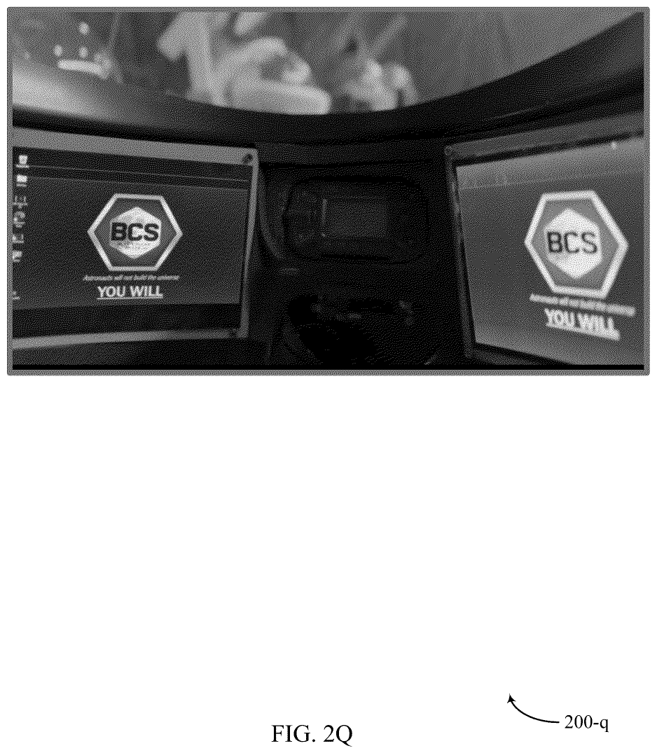

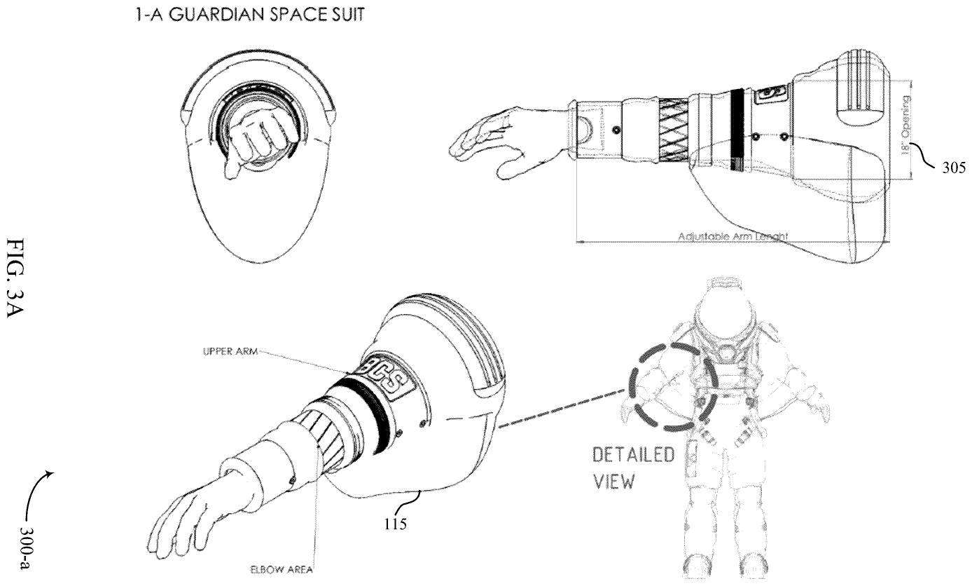

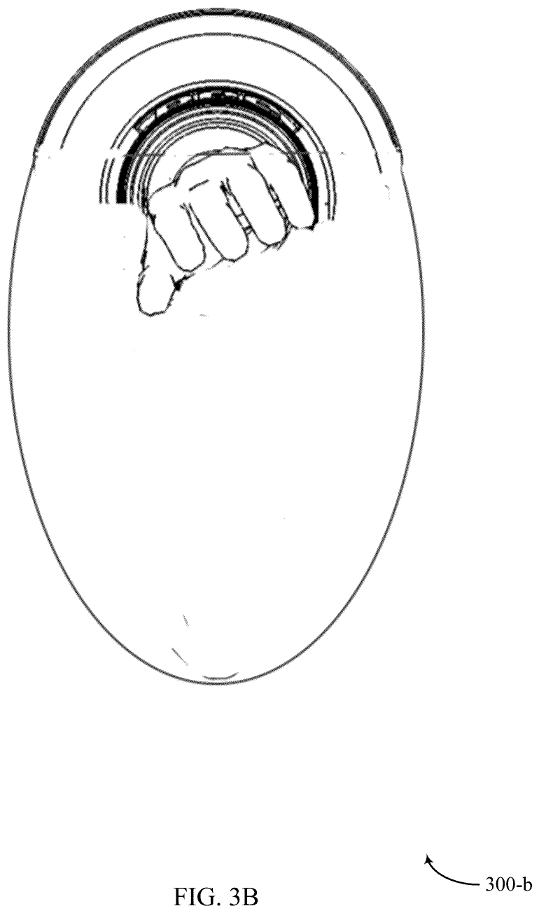

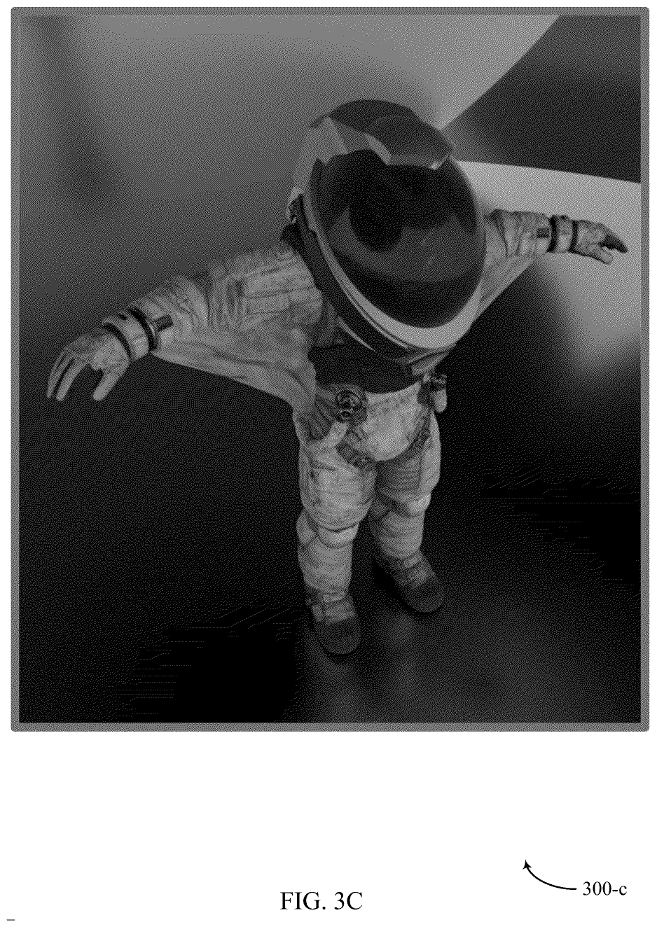

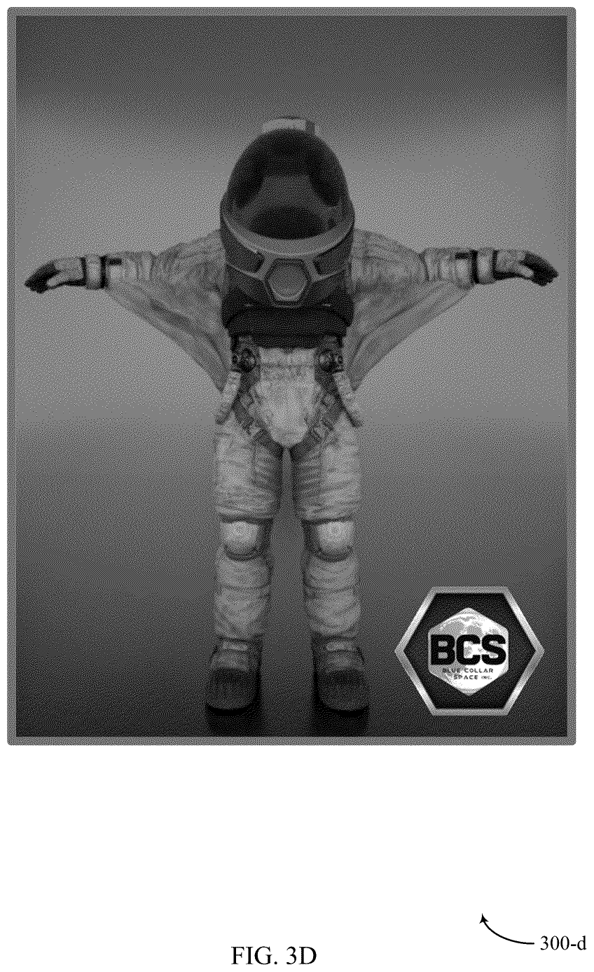

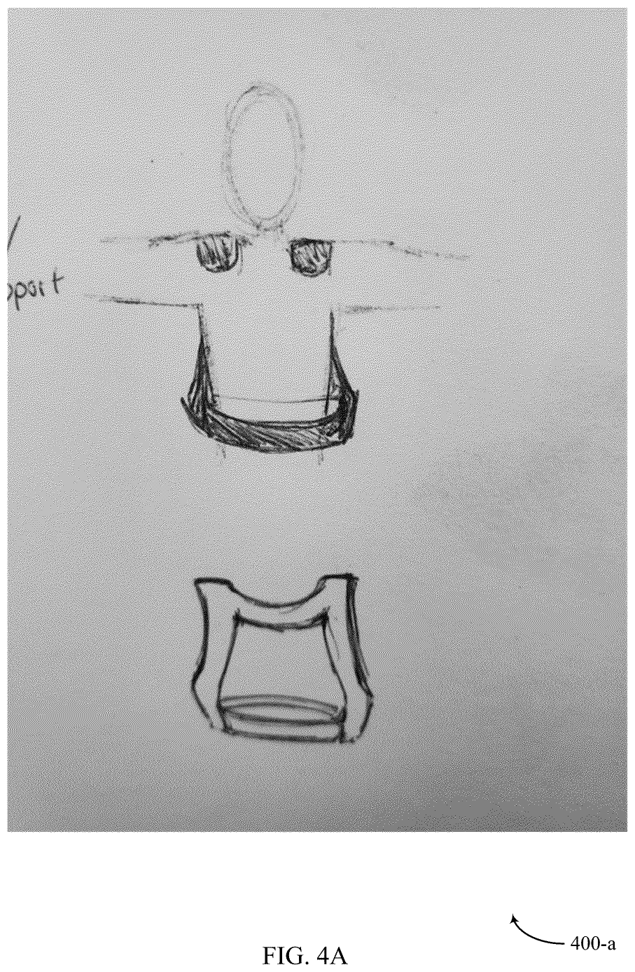

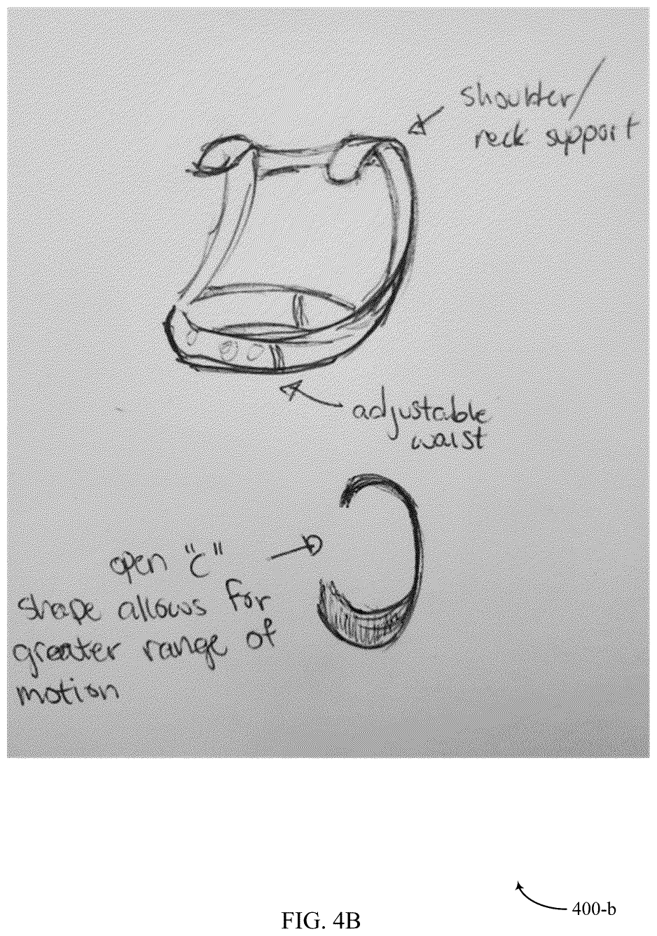

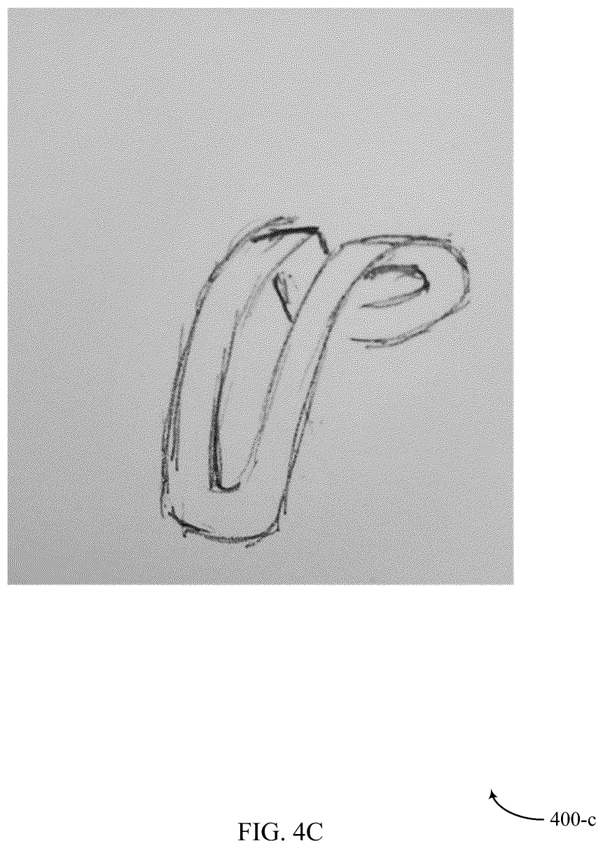

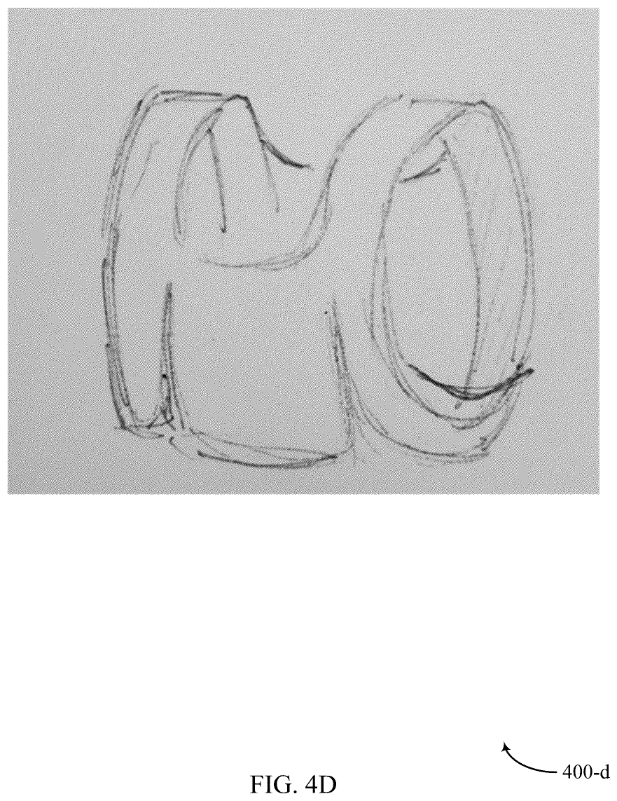

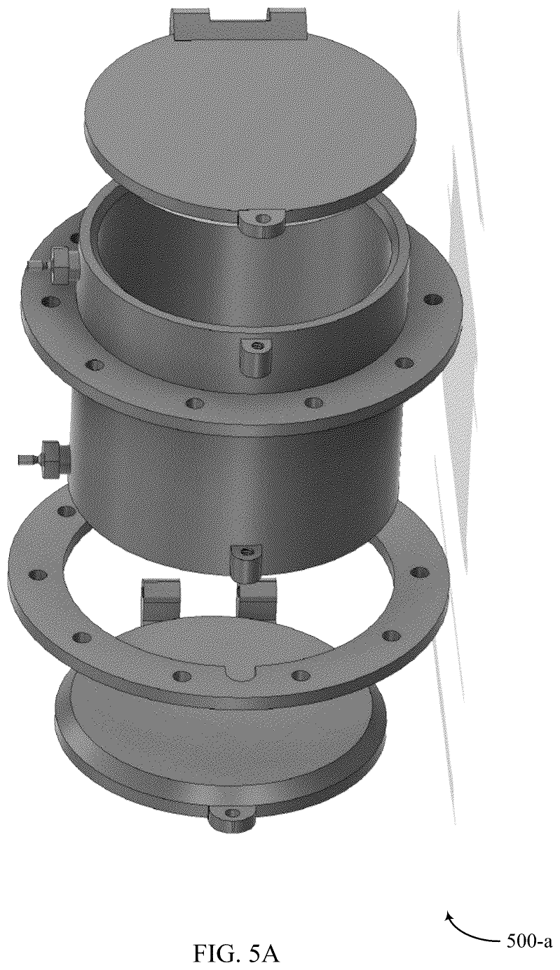

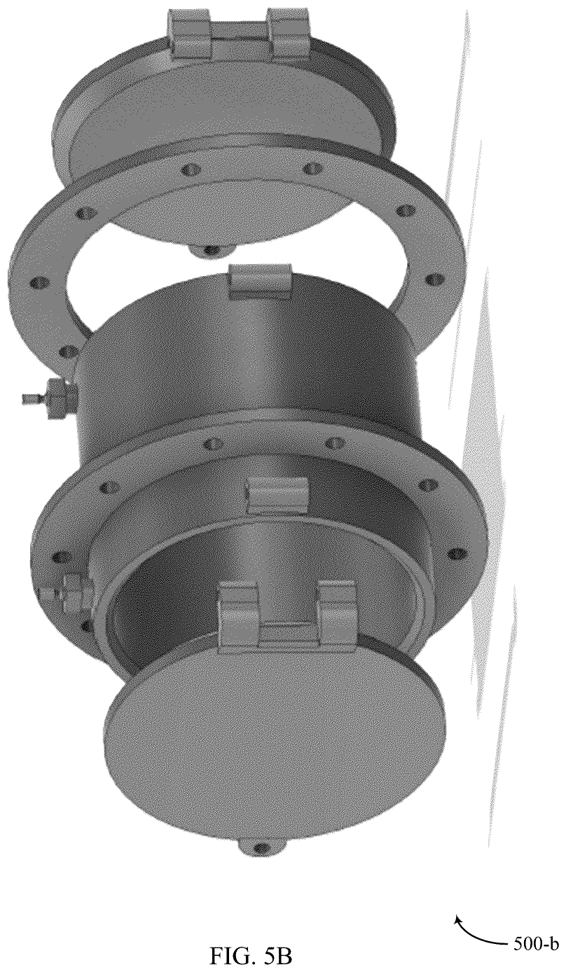

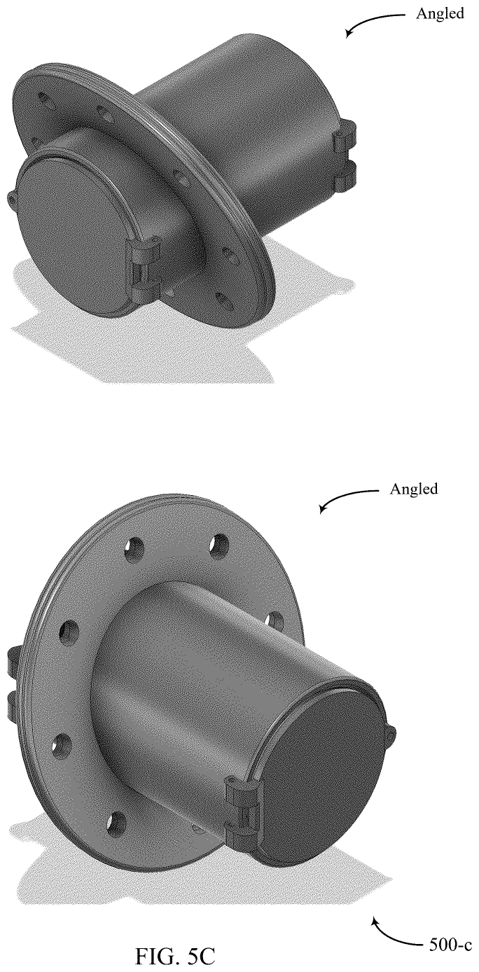

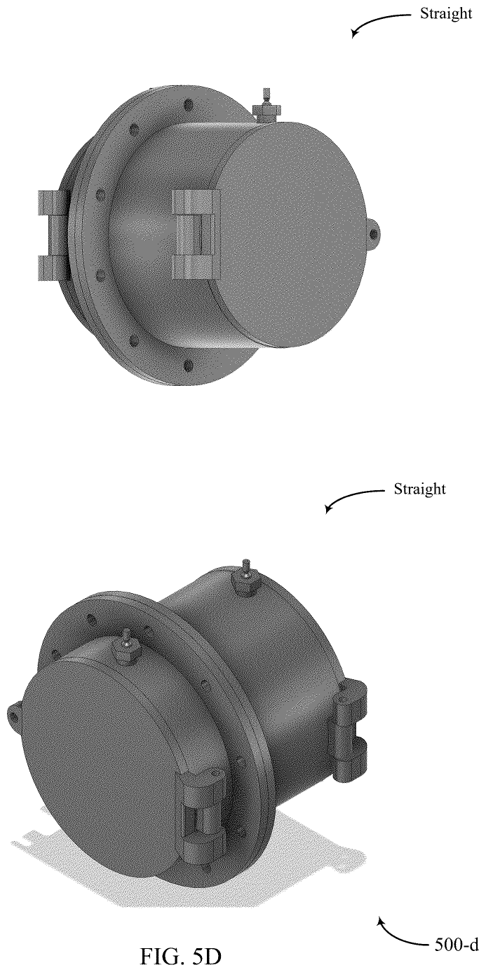

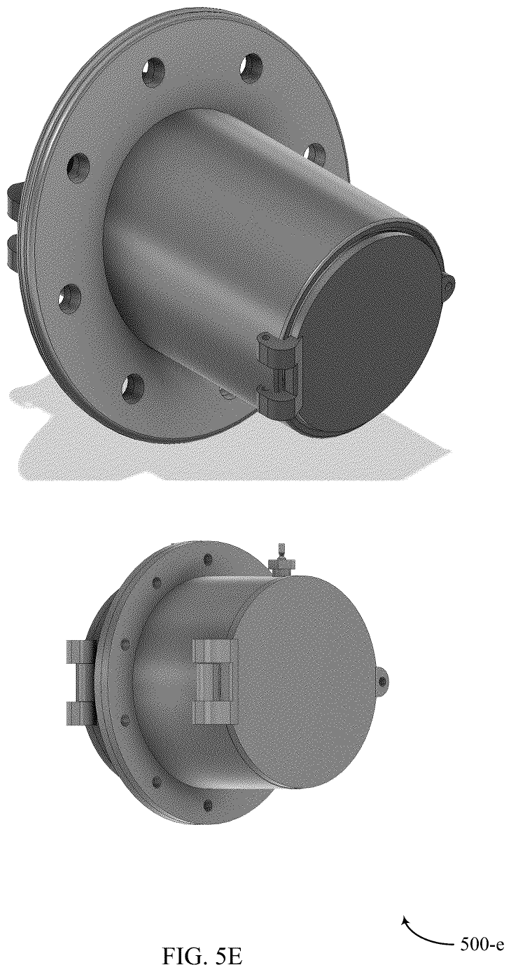

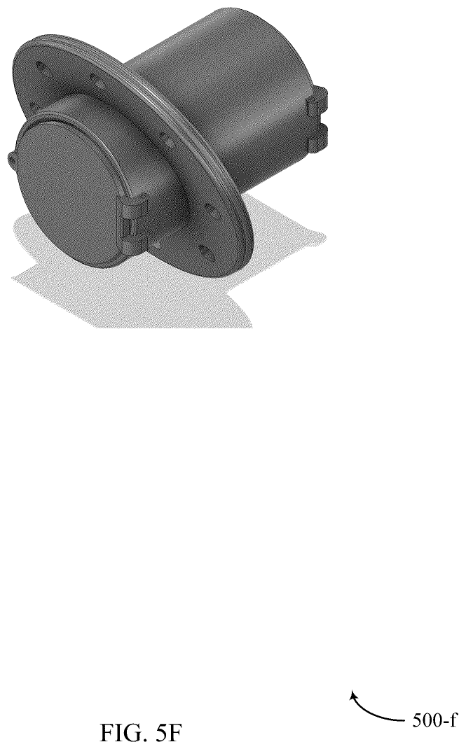

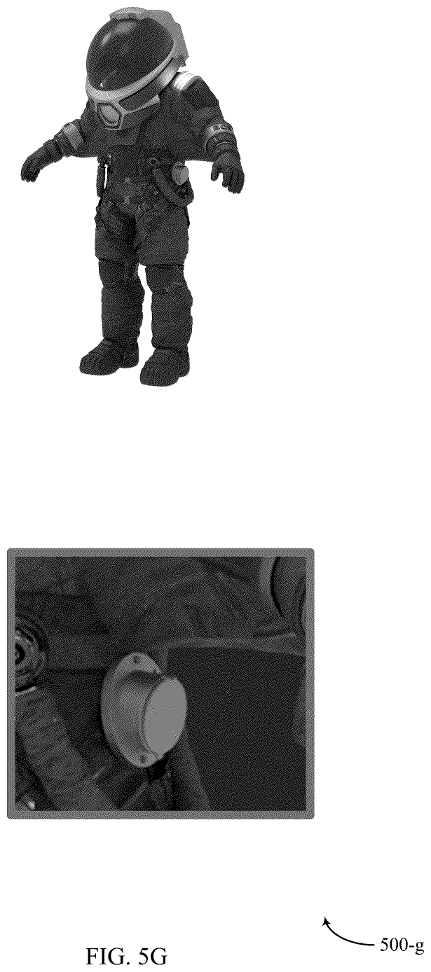

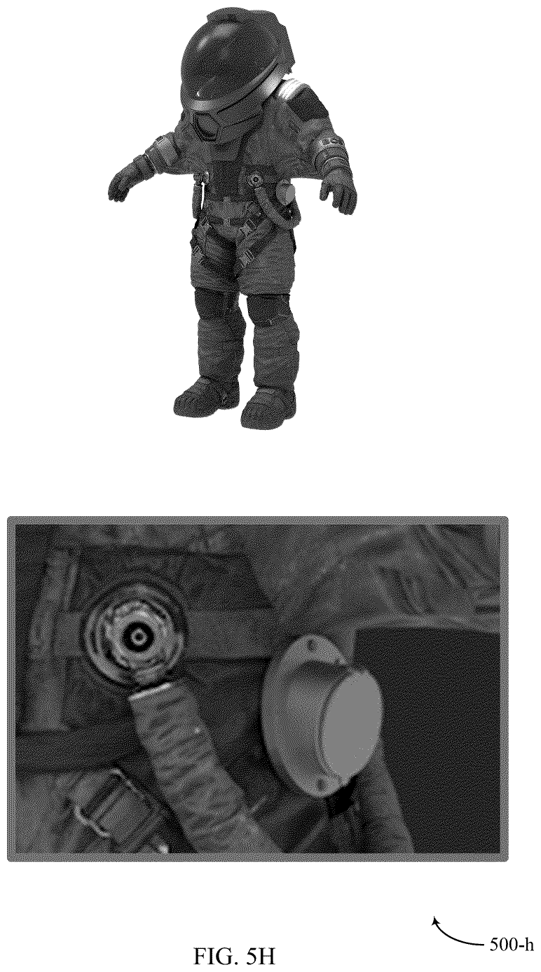

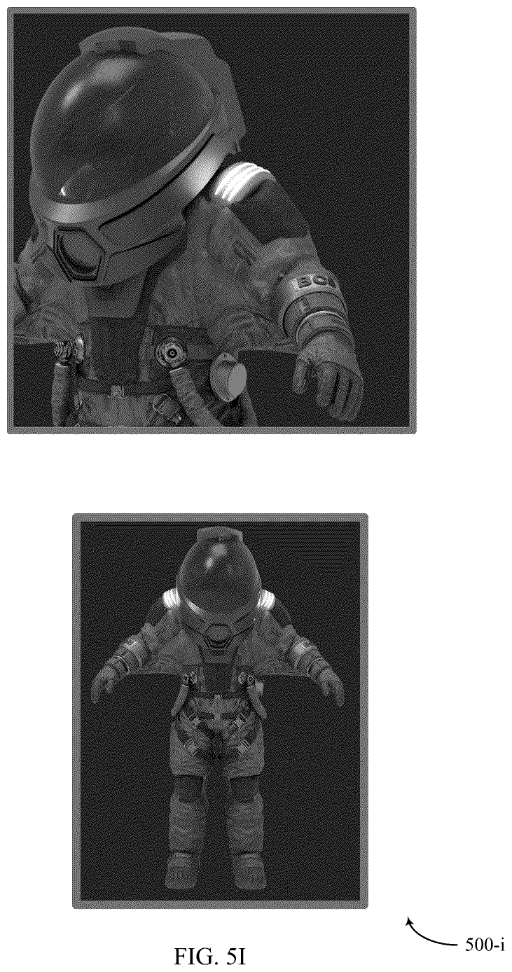

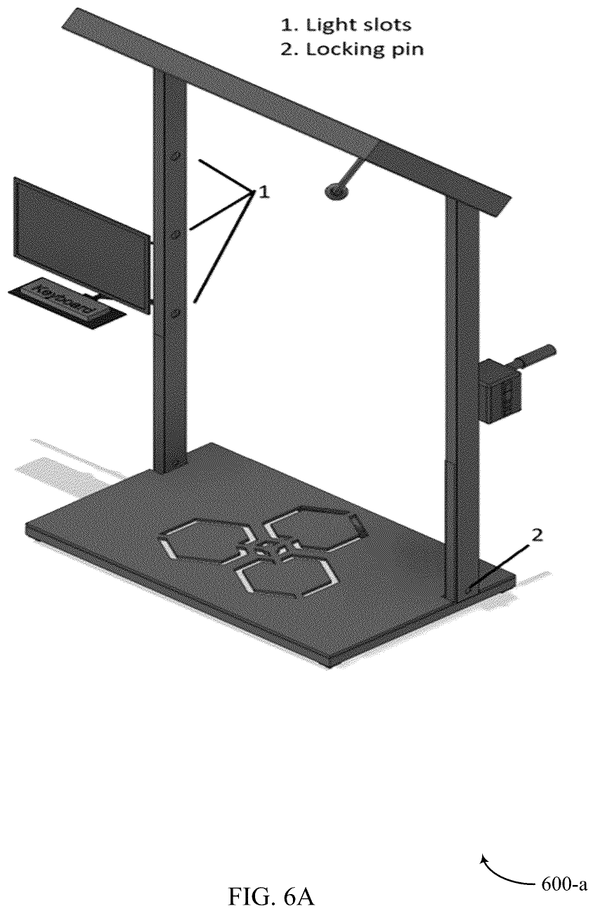

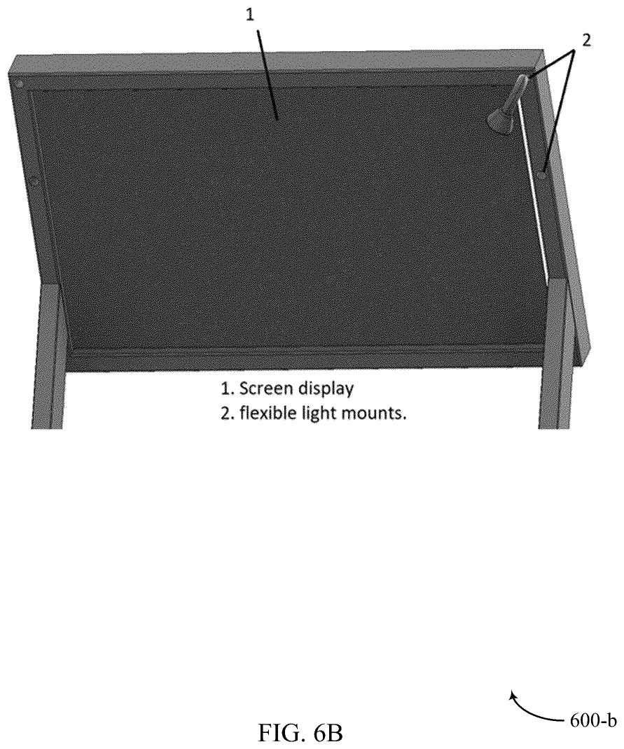

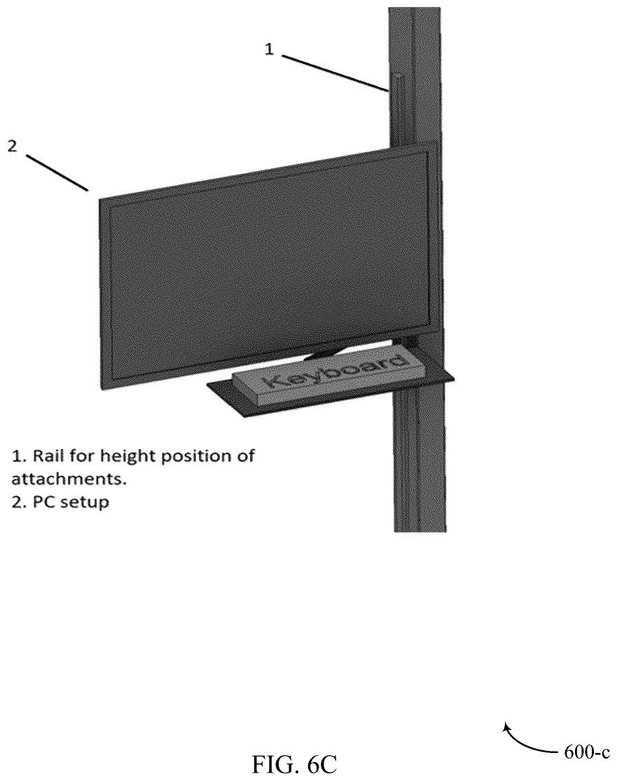

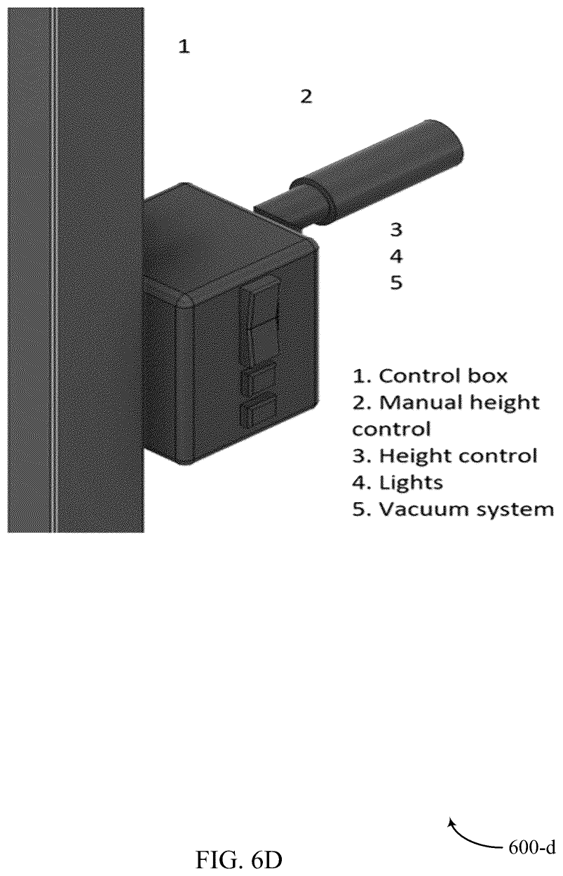

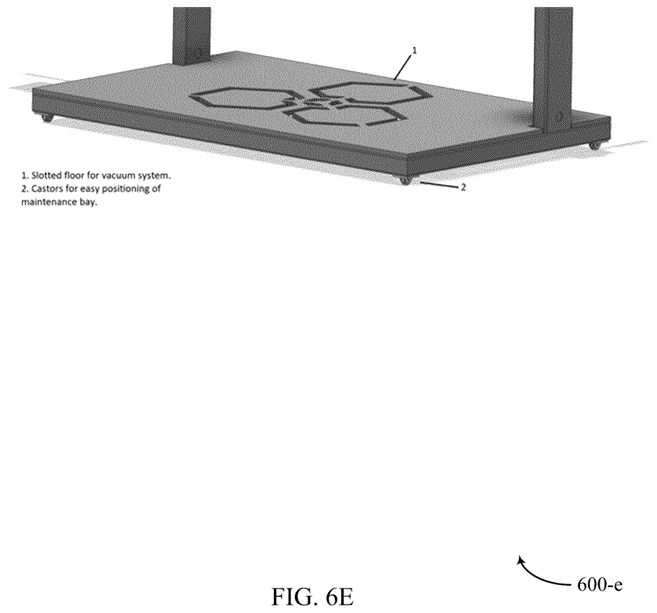

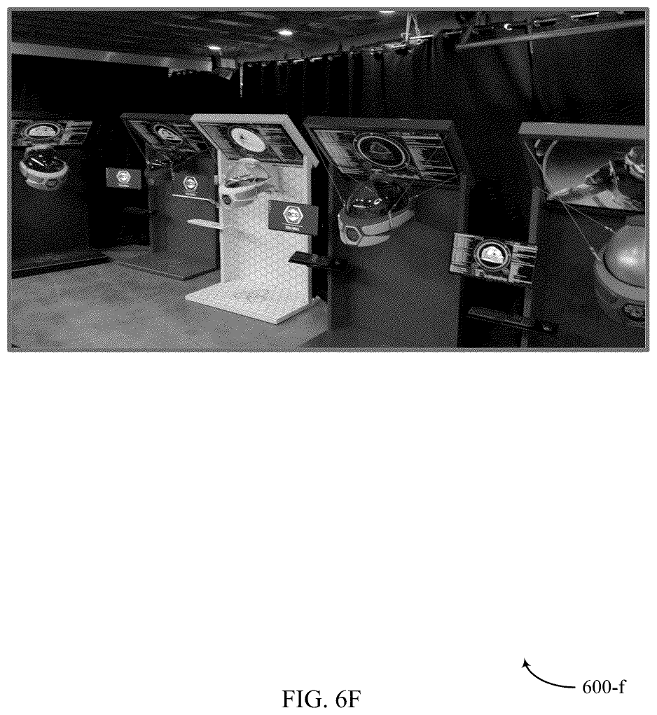

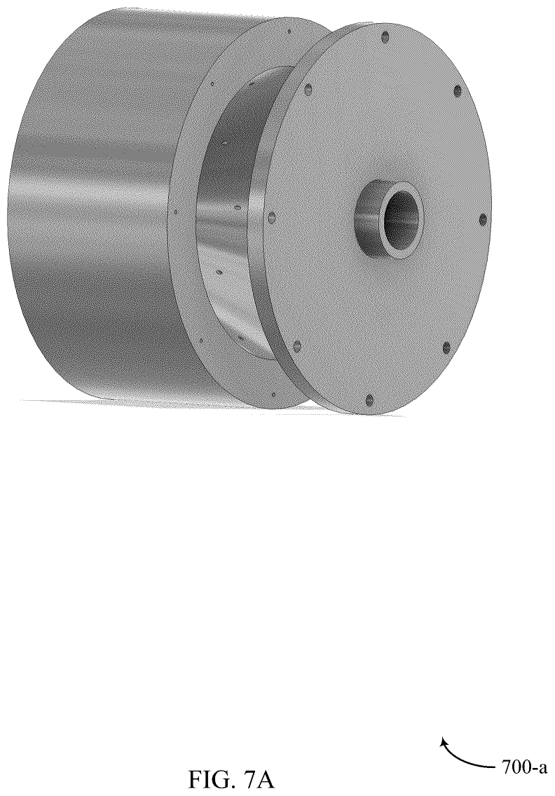

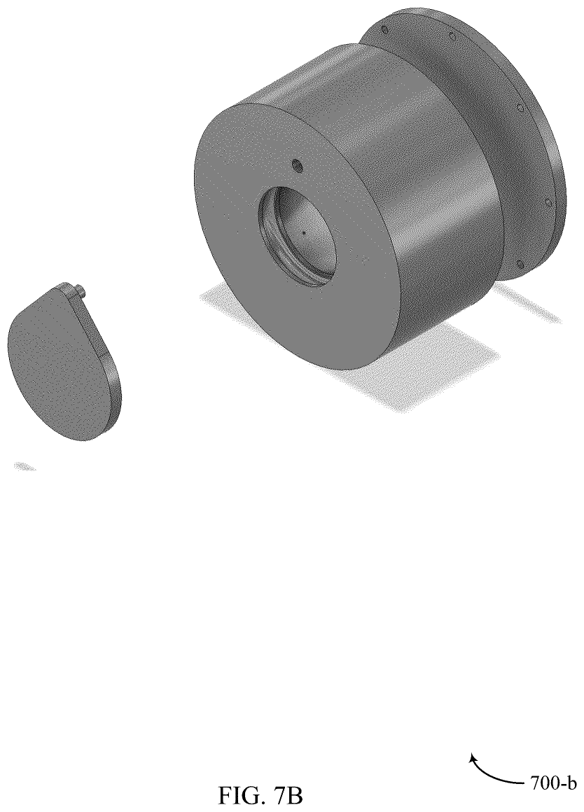

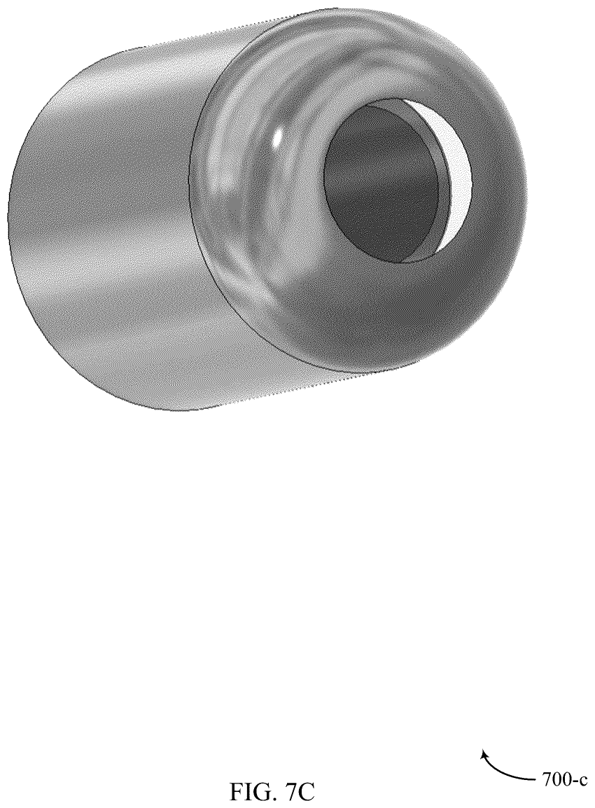

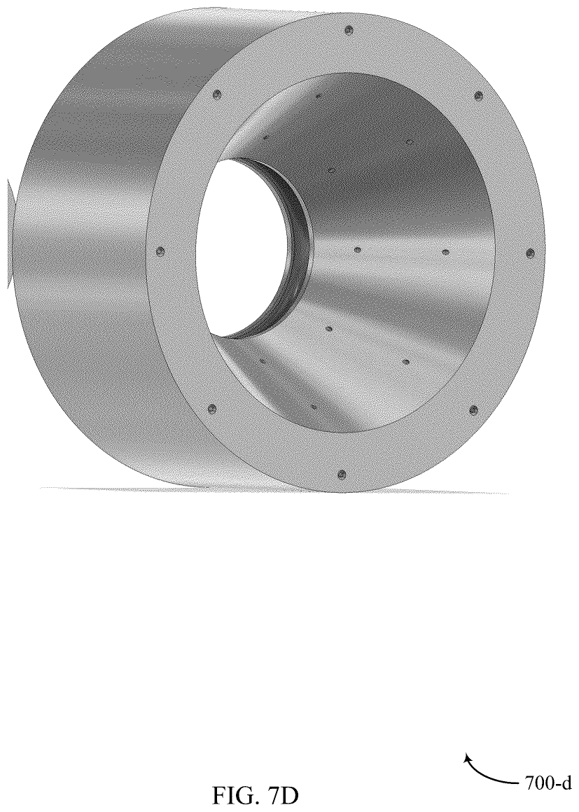

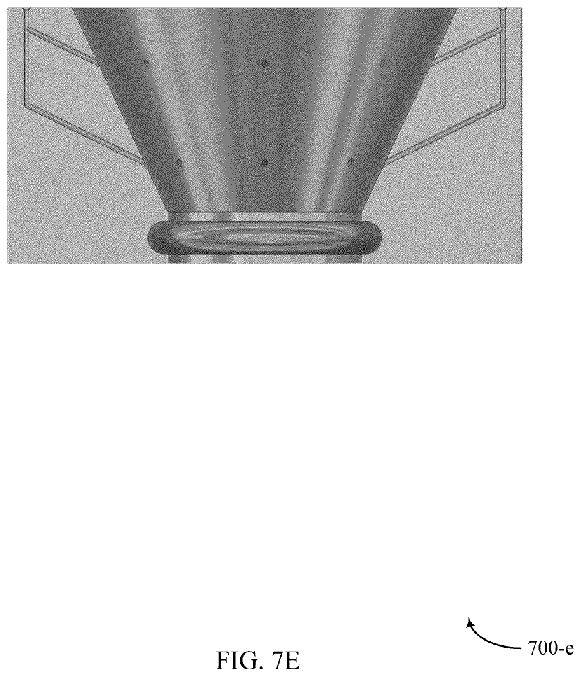

As illustrated throughout FIGS. 1A through 1L, the spacesuit 100 may include various components on a top portion (e.g., the wingsuit 110 and the helmet 105), such as a top frame, a shoulder fish bone, a wrist lock (e.g., compartment for D ring connector sewn to the suit), a top adjusting device, an elbow portion, among other examples. Similarly, the spacesuit 100 may include various components on the pant 125 (e.g., a bottom portion), such as a frame, a fish bone, a lock (e.g., a compartment for D ring connector sewn to the suit), and an adjusting device.

In some examples, the spacesuit 100 may include an expulsion portion (e.g., via an airlock component, further illustrated herein with reference to FIGS. 5A and 5B), which may enable the expulsion of waste from the spacesuit 100 during operations. Further, the spacesuit 100 may include an exoskeleton (not shown), one or more cameras (e.g., providing a 360 degree view), a communications package (such as components to facilitate Bluetooth communications, which may be integrated into the helmet 105 and a backpack illustrated in FIG. 1C), an emergency beacon (e.g., both IR and overt systems), internal cargo pockets (e.g., six to eight cargo pockets to hold personal items, among other examples).

In some examples, the spacesuit 100 may be connected to a maintenance bay, where the maintenance bay may be utilized by personnel to run diagnostics on the suit, repair damages to the suit, test the suit, among other examples. In such examples, the maintenance bay may connect to the spacesuit 100 via ports within the helmet 105 and may communicate with various computers of the spacesuit 100 via various communication protocols, such as Bluetooth, I2C, UART, USB, Modbus, PROFIBUS, UDP, HTTP, intersystem protocols, among other examples. The maintenance bay may be further described herein with reference to FIGS. 6A through 6E.

FIGS. 2A through 2Q show examples a helmet 200 of the spacesuit for high altitude and space environments in accordance with examples described herein. The helmet 200 may be an example of the helmet 105, as described herein with reference to FIGS. 1A through 1L. As illustrated, the helmet 200 may include an helmet body, a helmet visor coupled with the helmet body, a keyboard positioned on an inner portion of the helmet body, one or more touchscreen computers on an inner portion of the helmet body, an exterior touchscreen (e.g., front screen) positioned on an outer portion of the helmet body, a radio on an inner portion of the helmet body, or any combination thereof.

The helmet 200 may have an oval shape. In some examples, the spacesuit 100 may include a chest piece, where the helmet 200 may be positioned over the center of the chest piece, and where the chest piece may include the exterior touchscreen (e.g., exterior video touchscreen). The helmet 200 may also include a lower back section (e.g., utilized for computer components), an upper back section (utilized for a communication package), a top (e.g., crown), utilized for camera ports, IR, and emergency beacons, and include a top spine utilized for antenna arrays for communication packages.

As described and illustrated, the helmet 200 may include various computer components. For example, the helmet 200 may include one or two seven inch bendable touchscreens, include a mini two terabyte computer, Raspberry Pi, or both, include various computer links for associated software applications. The helmet 200 may also support various communication standards, such as link-16, SATCOMs, UHF and VHF, and HF communication standards.

In some examples, the quantity of touchscreen computers mounted on the inner portion of the helmet body may be based on a size of the helmet 200, on a purpose of the spacesuit 100, or both. For example, the helmet 200 may include a single touchscreen (e.g., computer screen, monitor) for small helmets 200 (e.g., utilized for supervisors or short missions) and include two touchscreens for medium helmets 200 (e.g., utilized for standard missions or a normal sized person), for large helmets 200 (e.g., utilized for extended missions or a large sized person), and for extra-large helmets 200 (e.g., utilized for long missions and external connections).

The helmet 200 may be formed in various dimensions. For example, the helmet 200 may be 18 inches in length by 14 inches in width by 12 inches tall (e.g., for a helmet designated as small), 20 inches in length by 16 inches in width by 12 inches tall (e.g., for a helmet designated as medium), 22 inches in length by 18 inches in width by 12 inches tall (e.g., for a helmet designated as large), or 24 inches in length by 20 inches in width by 12 inches tall (e.g., for a helmet designated as extra-large). In such examples, the dimensions of the helmet 200 may facilitate the ability of the astronaut to bring their hands into the helmet 200 and utilize the various components within the helmet 200, while satisfying current NASA and SpaceX hatch size requirements.

The helmet 200 may be formed to the wingsuit 110 via a pad that is connected to the helmet and then separately connected to the wingsuit 110. The helmet 200 may further include an emergency release (e.g., that is associated with an authorized zipper on the spacesuit 100). The helmet 200 may include various internal pockets for personal items, media connectors (e.g., for personal media items/cell phones), include adjustment capabilities (e.g., straps inside of the helmet 200 to adjust the position of the helmet 200 on the user), an emergency breathing device, a hazard material ejection airlock, among other examples.

FIGS. 3A through 3D show sleeves 300 of a wingsuit of the spacesuit for high altitude and space environments in accordance with aspects of the present disclosure. The sleeves 300 may be an example the sleeves 115, as described herein with reference to FIGS. 1A through 1L. The sleeves 300 may include an opening 305 that is attached to a body of the wingsuit, where the opening 305 may enable the user of the wingsuit 110 to remove their hands and insert their hands into the helmet 105 of the spacesuit 100. To enable such functionality, the openings 305 of the sleeves 300 may include dimensions that are greater than those of the ends of the sleeves 300. As an illustrative example, the openings 305 of the sleeves 300 may be 14 inches by 8 inches (e.g., for a suit designated as small), 16 inches by 10 inches (e.g., for a suit designated as medium), 18 inches by 12 inches (e.g., for a suit designated as large), or 20 inches by 14 inches (e.g., for a suit designated as extra-large).

FIGS. 4A through 4D show frames 400 of the spacesuit for high altitude and space environments in accordance with aspects of the present disclosure. Such frames 400 may be utilized to support the helmet 200 on the user.

FIGS. 5A through 5I show an airlock system 500 of the spacesuit for high altitude and space environments in accordance with aspects of the present disclosure. The airlock system 500 may be utilized to remove (e.g., expulse) waste from the wingsuit. The wingsuit may include one or multiple airlock systems 500, where each airlock system 500 may be placed at various portions of the wingsuit. As illustrated, the airlock system 500 may be located on a lateral side of a waist section of the spacesuit.

FIGS. 6A through 6F show examples a maintenance bay 600 of the spacesuit for high altitude and space environments in accordance with examples described herein. The maintenance bay 600 may be utilized by one or more operators of the spacesuit 100 to run diagnostics on the spacesuit 100, repair the spacesuit 100, charge the spacesuit 100, among other examples.

The maintenance bay 600 may include a base (e.g., floor) with two brackets, one on each side of the base. The base may also include slotted floors, for example, to be used for a vacuum system. The base may also include castors for positioning of the maintenance bay 600 (e.g., mobility of the maintenance bay 600). The maintenance bay may further include a screen display that is attached to the base via two poles. The screen display may include flexible light mounts on a frame of the screen display. Each respective pole may be inserted into a respective bracket and be held in the bracket via a respective locking pin.

Each pole may include one or more slots for lights (e.g., light slots). Additionally, one or both poles may include rails for height position of attachments. For example, a computing setup may be attached to one or more both poles via the rails. Similarly, a control box may be attached to one or more both poles via the rails. The control box may include a manual height control, a height control (e.g., automatic or electrical height control), a switch for operating various lights on the maintenance bay 600, a switch to operate the vacuum system on the base of the maintenance bay 600, or any combination thereof.

FIGS. 7A through 7E show examples a dust-free fiber optic port 700 of the spacesuit for high altitude and space environments in accordance with examples described herein. The dust-free fiber optic port may include a chamber that allows a fiber optic cable to be inserted and directly link to the internal computing system of the suits. Accordingly, when the physical cover of the port 700 is moved, a switch is triggered, which may open a valve that releases compressed ionized air through small pathways in the port socket to remove and/or prevent dust from entering the port. The inside of the port is conical shaped, to aid in expelling dust. Once the fiber optic plug is fully inserted, the air flow may shut off and inflate a tiny seal in at the front, preventing dust from re-entering. Both ends of the cable may be separated by a small gap to include a protective lens so that the cable ends do not become damaged. The fiber optic cable that is inserted may have a cover designed to have a relatively small-focused lens inside to compensate for that gap, so that there is no loss during transmission.

The following aspects are illustrative only and do not limit the scope of the present disclosure or the appended claims.

Aspect 1. A spacesuit for high altitude and space environments, comprising: a helmet comprising at least one touchscreen on an inner surface of the helmet; a wing suit formed directly onto the helmet, the wing suit comprising a first sleeve and a second sleeve, wherein respective first openings of the first sleeve and the second sleeve are directly attached to a body of the wing suit, wherein the respective first openings of the first sleeve and the second sleeve are configured to facilitate movement of hands of an occupant of the spacesuit from the first sleeve and the second sleeve into the helmet; and a pant configured to couple with the wing suit via an airtight lock.

Aspect 2. The spacesuit of aspect 1, wherein the respective first openings of the first sleeve and the second sleeve are collapsible.

Aspect 3. The spacesuit of any of aspects 1 through 2, wherein the dimensions of the helmet comprise 18 inches in length by 14 inches in width by 12 inches tall.

Aspect 4. The spacesuit of any of aspects 1 through 2, wherein the dimensions of the helmet comprise 20 inches in length by 16 inches in width by 12 inches tall.

Aspect 5. The spacesuit of any of aspects 1 through 2, wherein the dimensions of the helmet comprise 24 inches in length by 20 inches in width by 12 inches tall.

Aspect 6. The spacesuit of any of aspects 1 through 5, wherein the dimensions of the respective first openings of the first sleeve and the second sleeve comprise 14 inches tall by 8 inches wide.

Aspect 7. The spacesuit of any of aspects 1 through 5, wherein the dimensions of the respective first openings of the first sleeve and the second sleeve comprise 16 inches tall by 10 inches wide.

Aspect 8. The spacesuit of any of aspects 1 through 5, wherein the dimensions of the respective first openings of the first sleeve and the second sleeve comprise 18 inches tall by 12 inches wide.

Aspect 9. The spacesuit of any of aspects 1 through 5, wherein the dimensions of the respective first openings of the first sleeve and the second sleeve comprise 20 inches tall by 14 inches wide.

Aspect 10. The spacesuit of any of aspects 1 through 9, wherein the helmet further comprises: an external touchscreen positioned on a front exterior portion of the helmet, the external touchscreen configured to display vitals of the occupant of the spacesuit and be a backup communications panel.

Aspect 11. The spacesuit of any of aspects 1 through 10, wherein the helmet further comprises: one or more cameras on an exterior of the helmet, the one or more cameras configured to obtain a 360-degree view of surroundings of the spacesuit, wherein the at least one touchscreen on the inner surface is configured to display the 360-degree view of the surroundings of the spacesuit.

Aspect 12. The spacesuit of any of aspects 1 through 11, wherein a quantity of touchscreens mounted on the inner surface of the helmet is based on a size of the helmet, a purpose of the spacesuit, or both.

Aspect 13. The spacesuit of any of aspects 1 through 12, wherein the helmet further comprises a keyboard positioned on the inner surface of the helmet, a radio positioned on the inner surface of the helmet, or both.

Aspect 14. The spacesuit of any of aspects 1 through 13, wherein the helmet further comprises one or more internal pockets for personal items, an emergency breathing device, or both.

Aspect 15. The spacesuit of any of aspects 1 through 14, further comprising: an airlock system coupled with the wing suit and configured to transfer waste from the spacesuit, wherein the airlock system is located on a lateral side of a waist section of the spacesuit.

Aspect 16. The spacesuit of any of aspects 1 through 15, wherein the wing suit comprises one or more D-rings at a waist of the spacesuit, one or more D-rings at the first sleeve and the second sleeve of the wing suit, or both.

Aspect 17. The spacesuit of any of aspects 1 through 16, further comprising: an internal protection layer constructed from quilted material with layered XRI Gel, wherein the internal protection layer comprises one or more low-voltage wires running through quilted sections of the internal protection layer to facilitate temperature control.

Aspect 18. The spacesuit of aspect 17, wherein a temperature of the internal protection layer is adjustable via the at least one touchscreen on the inner surface of the helmet.

Aspect 19. The spacesuit of any of aspects 1 through 18, further comprising a frame configured to support the helmet on the spacesuit.

Aspect 20. The spacesuit of any of aspects 1 through 19, wherein the helmet is formed to the wing suit via a pad connected to the helmet and separately connected to the wing suit, and wherein the helmet comprises an emergency release.

What is claimed is:

1. A spacesuit for high altitude and space environments, comprising:
a helmet comprising at least one touchscreen on an inner surface of the helmet;
a wing suit formed directly onto the helmet, the wing suit comprising a first sleeve and a second sleeve, wherein respective first openings of the first sleeve and the second sleeve are directly attached to a body of the wing suit, wherein the respective first openings of the first sleeve and the second sleeve are configured to facilitate movement of hands of an occupant of the spacesuit from the first sleeve and the second sleeve into the helmet; and
a pant configured to couple with the wing suit via an airtight lock.

2. The spacesuit of claim 1, wherein the respective first openings of the first sleeve and the second sleeve are collapsible.

3. The spacesuit of claim 1, wherein dimensions of the helmet comprise 18 inches in length by 14 inches in width by 12 inches tall.

4. The spacesuit of claim 1, wherein dimensions of the helmet comprise 20 inches in length by 16 inches in width by 12 inches tall.

5. The spacesuit of claim 1, wherein dimensions of the helmet comprise 24 inches in length by 20 inches in width by 12 inches tall.

6. The spacesuit of claim 1, wherein dimensions of the respective first openings of the first sleeve and the second sleeve comprise 14 inches tall by 8 inches wide.

7. The spacesuit of claim 1, wherein dimensions of the respective first openings of the first sleeve and the second sleeve comprise 16 inches tall by 10 inches wide.

8. The spacesuit of claim 1, wherein dimensions of the respective first openings of the first sleeve and the second sleeve comprise 18 inches tall by 12 inches wide.

9. The spacesuit of claim 1, wherein dimensions of the respective first openings of the first sleeve and the second sleeve comprise 20 inches tall by 14 inches wide.

10. The spacesuit of claim 1, wherein the helmet further comprises:
an external touchscreen positioned on a front exterior portion of the helmet, the external touchscreen configured to display vitals of the occupant of the spacesuit and be a backup communications panel.

11. The spacesuit of claim 1, wherein the helmet further comprises:
one or more cameras on an exterior of the helmet, the one or more cameras configured to obtain a 360-degree view of surroundings of the spacesuit, wherein the at least one touchscreen on the inner surface is configured to display the 360-degree view of the surroundings of the spacesuit.

12. The spacesuit of claim 1, wherein a quantity of touchscreens mounted on the inner surface of the helmet is based on a size of the helmet, a purpose of the spacesuit, or both.

13. The spacesuit of claim 1, wherein the helmet further comprises a keyboard positioned on the inner surface of the helmet, a radio positioned on the inner surface of the helmet, or both.

14. The spacesuit of claim 1, wherein the helmet further comprises one or more internal pockets for personal items, an emergency breathing device, or both.

15. The spacesuit of claim 1, further comprising:
an airlock system coupled with the wing suit and configured to transfer waste from the spacesuit, wherein the airlock system is located on a lateral side of a waist section of the spacesuit.

16. The spacesuit of claim 1, wherein the wing suit comprises one or more D-rings at a waist of the spacesuit, one or more D-rings at the first sleeve and the second sleeve of the wing suit, or both.

17. The spacesuit of claim 1, further comprising:
an internal protection layer constructed from quilted material with layered XRI Gel, wherein the internal protection layer comprise one or more low-voltage wires running through quilted sections of the internal protection layer to facilitate temperature control.

18. The spacesuit of claim 17, wherein a temperature of the internal protection layer is adjustable via the at least one touchscreen on the inner surface of the helmet.

19. The spacesuit of claim 1, further comprising a frame configured to support the helmet on the spacesuit.

20. The spacesuit of claim 1, wherein the helmet is formed to the wing suit via a pad connected to the helmet and separately connected to the wing suit, and wherein the helmet comprises an emergency release.
